(19) United States
(12) Patent Application Publication
(10) Pub. No.: US 2017/0344999 A1
(43) Pub. Date: Nov. 30, 2017

(54) PAYMENT METHOD AND ELECTRONIC DEVICE USING LOOP ANTENNAS

(71) Applicant: Samsung Electronics Co., Ltd., Gyeonggi-do (KR)

(72) Inventors: Saeoeek BARK, Gyeongsangbuk-do (KR); Byungsu LEE, Daegu (KR); Chulhyung YANG, Gyeongsangbuk-do (KR); Jiwoo LEE, Gyeongsangbuk-do (KR)

(21) Appl. No.: 15/607,890

(22) Filed: May 30, 2017

(30) Foreign Application Priority Data
May 30, 2016 (KR) 10-2016-0066598

(51) Int. Cl. G06Q 20/40; G06K 19/077; G06K 19/06; G06Q 20/38; G06Q 20/32

(52) U.S. Cl. CPC G06Q 20/409; G06Q 20/40145; G06Q 20/388; G06Q 20/327; G06K 19/06206; G06Q 20/322; G06K 19/07779; G06Q 20/3224

(57) ABSTRACT

A mobile electronic device and method are provided. The mobile electronic device includes a printed circuit board (PCB) built into a central area of the mobile electronic device and including at least one of a first loop antenna or a second loop antenna; a processor electrically connected to the at least one of the first loop antenna or the second loop antenna; a memory electrically connected to the processor, and configured to store card information related to a payment, wherein the processor is configured to determine whether the mobile electronic device is close to an external payment terminal, using the first loop antenna; and generate, if the mobile electronic device is close to the external payment terminal, a magnetic field signal including the card information, via the at least one of the first loop antenna or the second loop antenna, in response to a payment command.

### PRIORITY

This application claims priority under 35 U.S.C. §119(a) to a Korean Patent Application filed on May 30, 2016 in the Korean Intellectual Property Office and assigned Serial number 10-2016-0066598, the entire disclosure of which is incorporated herein by reference.

### BACKGROUND

### 1. Field of the Disclosure

The present disclosure relates generally to a payment method using loop antennas for electronic devices, and an electronic device adapted to the method, and more particularly, to a payment system capable of detecting a time when a mobile terminal approaches a payment processing device, determining a time when the mobile terminal executes a payment function, and providing a user with a convenient payment experience when the payment function starts.

### 2. Description of Related Art

With the development of technology and the spread of mobile terminals, mobile terminals have evolved to be equipped with payment functions. Payment methods are achieved via various techniques, such as near field communication (NFC), magnetic secure transmission (MST), etc. Mobile terminals must include hardware components capable of supporting an NFC or MST mode in order to support corresponding payment modes. For example, a mobile terminal may include coils (e.g., a loop antenna) corresponding to payment modes, so that the mobile terminal may create magnetic field signals for payment modes via the corresponding coils.

Therefore, mobile terminals with coils may be used as a payment means.

In order to use a mobile terminal as a payment means, the mobile terminal user must operate the mobile terminal in a payment sequence (e.g., the order of payment). For example, the user may perform a user authentication process (e.g., fingerprint recognition, password input) to execute a payment function through his/her mobile terminal, and then hand over the mobile terminal to a cashier. The cashier may hold the mobile terminal near the point of sales (POS) terminal, thereby completing the payment process. That is, the mobile terminal is capable of continuously generating a magnetic field signal via the coil from the time when the user authentication process starts. The mobile terminal may be capable of repeating the transmission of a magnetic field signal generated by the coil to the POS terminal a preset number of times for a preset period of time, and then stopping, by the mobile terminal, the generation of a magnetic field signal after the preset number of times.

The time required for the generation of a magnetic field signal (e.g., a generation time) may be greater than or less than the time required from a time when a user authentication process starts to a time when a payment process is ended (e.g., the time required for making a payment). If the generation time of a magnetic field signal is greater than the time required for making a payment, mobile terminals may continue generating a magnetic field signal a preset number of times despite the completion of the payment process. In this case, mobile terminals consume power caused by the generation of magnetic field signals. On the other hand, if the generation time of a magnetic field signal is less than the time required for payment, mobile terminals may stop the generation of magnetic field signals before the payment process is completed. In this case, the user must repeat the payment sequence from the beginning.

### SUMMARY

The present disclosure provides a payment system which is capable of detecting a time when a mobile terminal approaches a payment processing device (e.g., a point of sales (POS) terminal, a payment terminal, etc.), determining a time when the mobile terminal executes a payment function, and providing a user with a convenient payment experience when the payment function starts at the determined time.

In addition, various embodiments of the present disclosure provide a payment system which is capable of allowing mobile terminals to execute a payment function from a time when the mobile terminal approaches a payment processing device, thereby minimizing power consumption.

In accordance with an aspect of the present disclosure, a mobile electronic device is provided. The mobile electronic device includes a printed circuit board (PCB) built into a central area of the mobile electronic device and including at least one of a first loop antenna or a second loop antenna; a processor electrically connected to the at least one of the first loop antenna or the second loop antenna; a memory electrically connected to the processor and configured to store card information related to a payment, wherein the processor is configured to determine whether the mobile electronic device is close to an external payment terminal, using the first loop antenna; and generate, if the mobile electronic device is close to the external payment terminal, a magnetic field signal including the card information, via the at least one of the first loop antenna or the second loop antenna, in response to a payment command.

In accordance with another aspect of the present disclosure, a payment method using loop antennas in a mobile electronic device is provided. The method includes determining whether the mobile electronic device is close to an external payment terminal, using a first loop antenna of a printed circuit board (PCB) which is built into a central area of the mobile electronic device; and generating, if the mobile electronic device is close to the external payment terminal, a magnetic field signal including card information to make a payment, via at least one of the first loop antenna or a second loop antenna of the PCB, in response to a payment command.

### BRIEF DESCRIPTION OF THE DRAWINGS

The above and other aspects, features and advantages of the present disclosure will be more apparent from the following detailed description, taken in conjunction with the accompanying drawings, in which:

FIG. 1 illustrates diagrams of an arrangement of a number of coils built into an electronic device according to an embodiment of the present disclosure;

FIGS. 2A and 2B are illustrations of a payment sequence using an electronic device according to an embodiment of the present disclosure;

FIG. 3 is a block diagram of an electronic device in a network environment according to an embodiment of the present disclosure;

FIG. 4 is a block diagram of an electronic device according to an embodiment of the present disclosure;

FIG. 5 is a block diagram of a program module according to an embodiment of the present disclosure;

FIGS. 6A, 6B, and 6C are diagrams of an electronic device which determines whether an electronic device approaches a payment processing device and performs a payment function according to an embodiment of the present disclosure;

FIGS. 7A and 7B are flowcharts of a method of determining whether an electronic device approaches a payment processing device and generating a magnetic field corresponding to a payment function if the electronic device approaches a payment processing device according to an embodiment of the present disclosure;

FIG. 8 illustrates diagrams of a result of determining whether an electronic device approaches a payment processing device according to an embodiment of the present disclosure;

FIG. 9 is a flowchart of a method of determining whether an electronic device approaches a payment processing device via a first coil, and providing a distance between the electronic device and the payment processing device according to an embodiment of the present disclosure;

FIG. 10 is a diagram of equations for measuring a distance between an electronic device and a payment processing device according to an embodiment of the present disclosure;

FIG. 11 illustrates a diagram and a table of induced voltages measured according to distances between an electronic device and a payment processing device according to an embodiment of the present disclosure;

FIG. 12 is a flowchart of a method of supporting a number of payment modes using a number of coils according to an embodiment of the present disclosure;

FIG. 13 illustrates waveform diagrams of induced voltages which are measured according to payment modes according to an embodiment of the present disclosure;

FIG. 14 is a flowchart of a method of determining whether a payment processing device and an electronic device are separated by a preset distance, using a first coil, and stopping a generation of a magnetic field from a second coil according to an embodiment of the present disclosure;

FIG. 15 is a flowchart of a method of determining whether an electronic device is close to a payment processing device; performing a payment function based on the determination; determining whether an electronic device is apart from a payment processing device; and stopping a payment function based on the determination according to an embodiment of the present disclosure;

FIG. 16 illustrates diagrams of a method of: determining whether an electronic device is close to a payment processing device; performing a payment function based on the determination; determining whether an electronic device is apart from a payment processing device; and stopping a payment function based on the determination according to an embodiment of the present disclosure;

FIG. 17 is a diagram illustrating a location and a shape of a flexible PCB (FPCB) installed in an electronic device according to an embodiment of the present disclosure; and

FIG. 18 is a cross-sectional side view of an electronic device including an FPCB according to an embodiment of the present disclosure.

### DETAILED DESCRIPTION OF EMBODIMENTS OF THE DISCLOSURE

Hereinafter, the present disclosure is described with reference to the accompanying drawings. Although certain embodiments are illustrated in the accompanying drawings and related detailed descriptions are discussed in the present disclosure, the present disclosure may have various modifications and several embodiments. However, various embodiments of the present disclosure are not intended to be limited to an implementation and it is intended that the present disclosure includes all changes, equivalents and/or substitutes included within the scope and spirit of the present disclosure, as defined by the accompanying claims and their equivalents. In connection with descriptions of the accompanying drawings, similar components are designated by the same reference numeral.

In various embodiments of the present disclosure, terms such as “include”, “have”, “may include” or “may have” may be construed to denote a certain characteristic, number, step, operation, element, component or a combination thereof, but are not intended to be construed to exclude the existence of or a possibility of an addition of one or more other characteristics, numbers, steps, operations, elements, components or combinations thereof.

In various embodiments of the present disclosure, the expressions “or” and “at least one of A and/or B” include any or all combinations of words listed together. For example, the expressions “A or B” and “at least A and/or B” may include A, B, or A and B.

The expressions “1”, “2”, “first”, and “second” used in various embodiments of the present disclosure may modify various components of the various embodiments but are not intended to limit the corresponding components. For example, the above expressions are not intended to limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element may be referred to as the first structural element.

If it is stated that a component is “(operatively or communicatively) coupled to” or “connected to” another component, the component may be directly coupled or connected to another component or a new component may exist between the component and another component. In contrast, if it is stated that a component is “directly coupled to” or “directly connected to” another component, a new component does not exist between the component and the other component. In the present disclosure, the expression “configured (or set) to do” may be interchangeable with the expressions, for example, “suitable for doing,” “having the capacity to do,” “designed to do,” “adapted to do,” “made to do,” and “capable of doing.” The expression “configured (or set) to do” is not intended to be used to refer to only something in hardware for which it is “specifically designed to do.” Instead, the expression “a device configured to do” may indicate that the device is “capable of doing” something with other devices or parts. For example, the expression “a processor configured (or set) to do A, B and C” may refer to a dedicated processor (e.g., an embedded processor) or a general purpose processor (e.g., a central processing unit (CPU) or an application processor (AP)) that may execute one or more software programs stored in a memory device to perform corresponding functions.

An electronic device according to various embodiments of the present disclosure may be a device including an antenna. For example, an electronic device may be one or more of a smart phone, a tablet personal computer (PC), a mobile phone, a video phone, an electronic book (e-book) reader, a desktop PC, a laptop PC, a netbook computer, a personal digital assistant (PDA), a portable multimedia player (PMP), a moving picture experts group audio layer 3 (MP3) player, a mobile medical application, a camera, and a wearable device (for example, a head-mounted device (HMD), such as electronic glasses, electronic clothes, an electronic bracelet, an electronic necklace, an electronic appcessory, an electronic tattoo, and a smart watch).

According to some embodiments of the present disclosure, an electronic device may be a smart home appliance having an antenna. A smart home appliance may include at least one of a television (TV), a digital video disk (DVD) player, an audio player, an air conditioner, a cleaner, an oven, a microwave oven, a washing machine, an air purifier, a set-top box, a TV box (for example, Samsung HomeSync®, Apple TV®, or Google TV™), game consoles, an electronic dictionary, an electronic key, a camcorder, and an electronic frame.

According to some embodiments of the present disclosure, an electronic device may include at least one of various types of medical devices (for example, a magnetic resonance angiography (MRA) device, a magnetic resonance imaging (MRI) device, a computed tomography (CT) device, a scanner, an ultrasonic device and the like), a navigation device, a global positioning system (GPS) receiver, an event data recorder (EDR), a flight data recorder (FDR), a vehicle infotainment device, electronic equipment for a ship (for example, a navigation device for a ship, a gyro compass and the like), avionics, a security device, a head unit for a vehicle, an industrial or home robot, an automated teller machine (ATM) of a financial institution, and a point of sale (POS) device of a shop.

According to some embodiments of the present disclosure, an electronic device may include at least one of furniture or a part of a building/structure, an electronic board, an electronic signature receiving device, a projector, and various types of measuring devices (for example, a water meter, an electricity meter, a gas meter, a radio wave meter and the like), which are equipped with an antenna. An electronic device may also be a combination of the devices listed above. Further, an electronic device may be a flexible device. However, an electronic device is not intended to be limited to the above described devices.

Hereinafter, an electronic device according to various embodiments of the present disclosure is described with reference to the accompanying drawings. The term “user” used herein may refer to a person who uses an electronic device or may refer to a device (e.g., an artificial intelligence electronic device) that uses an electronic device.

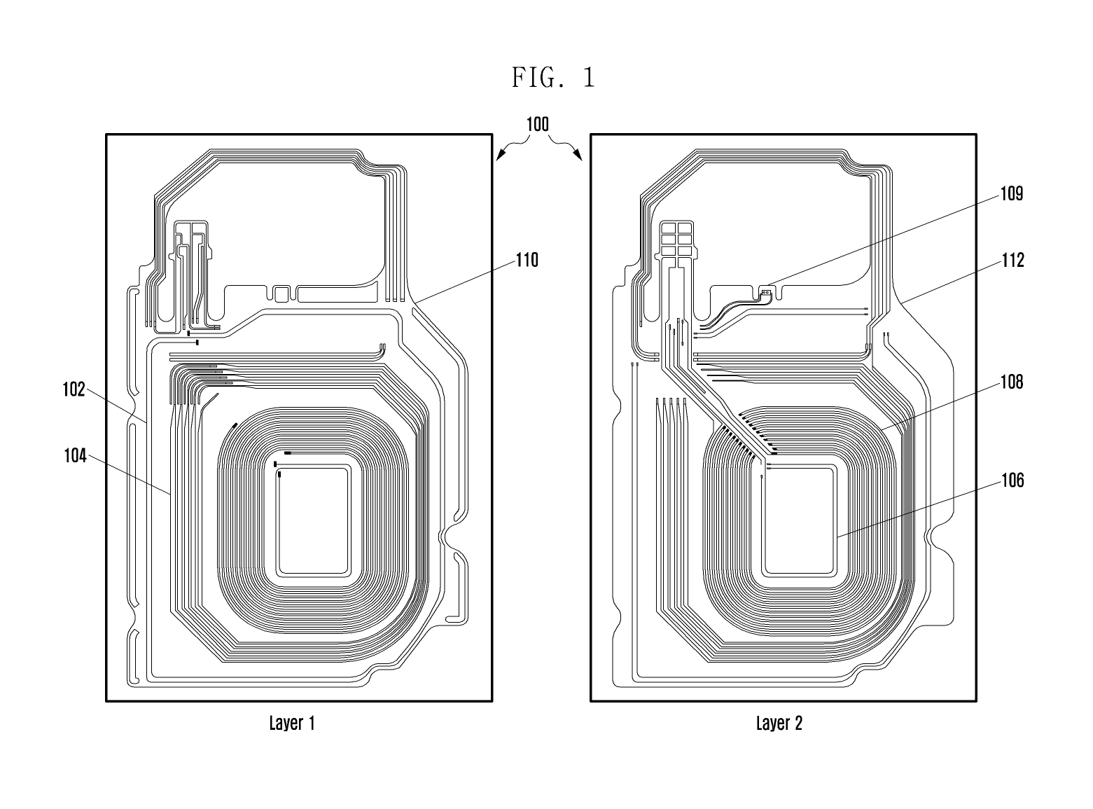

FIG. 1 illustrates diagrams of an arrangement of a number of coils built into an electronic device according to an embodiment of the present disclosure.

Referring to FIG. 1, an electronic device 100 is capable of supporting payment modes and including hardware components corresponding to the payment modes. For example, the electronic device 100 is capable of supporting coil-based payment modes (e.g., an MST payment mode, an NFC payment mode). That is, the electronic device 100 is capable of including a number of coils to support a number of payment modes. The coils may be loop antennas. In the following description, a coil is used in the same sense as a loop antenna. In order to support a number of payment modes, the electronic device 100 may be configured in such a way that a number of coils corresponding to individual payment modes are disposed in one or more FPCB x-y axis planes 110 and 112. For example, the electronic device 100 is configured in such a way that a first coil 102 corresponding to an NFC payment mode is disposed on an FPCB 110 and a second coil 104 corresponding to an MST payment mode is disposed on the FPCB 110. In addition, the electronic device 100 is configured to include a coil for performing other functions, such as a wireless charging function, etc. For example, the electronic device 100 may be configured to include a third coil 108 corresponding to a wireless charging function, e.g., a Wireless Power Consortium (WPC) coil. The electronic device 100 is also capable of induding a thermistor 109 for sensing temperature for a circuit. It should be understood that the electronic device 100 may also include a form of wire, instead of coils.

With reference to FIG. 1, the electronic device 100 may dispose a number of coils on the FPCBs 110 and 112, in layers, e.g., Layer 1 and Layer 2. Layer 1 and Layer 2 may be adjacently disposed on the front and rear sides of the electronic device 100. Layer 1 and Layer 2, including a number of coils, are electrically connected to each other. First coils 102 and 106 of a number of coils may be disposed in Layer 1 and Layer 2, respectively, in different forms. The arrangement of a number of coils, shown in FIG. 1, may vary depending on various factors of the electronic device 100, e.g., performance, installation space, etc. It should be understood that the arrangement of the coils is not limited to those shown in FIG. 1. MST, which is one of the payment modes, is a technology that generates a magnetic field within a range of proximity and transmits a magnetic field signal. The present disclosure is capable of converting information regarding tracks 1, 2 and 3 of a magnetic credit card into a magnetic field signal in an MST payment mode; and transmitting the magnetic field signal containing the information to a POS terminal (e.g., a payment processing device) via an MST coil corresponding to the MST payment mode.

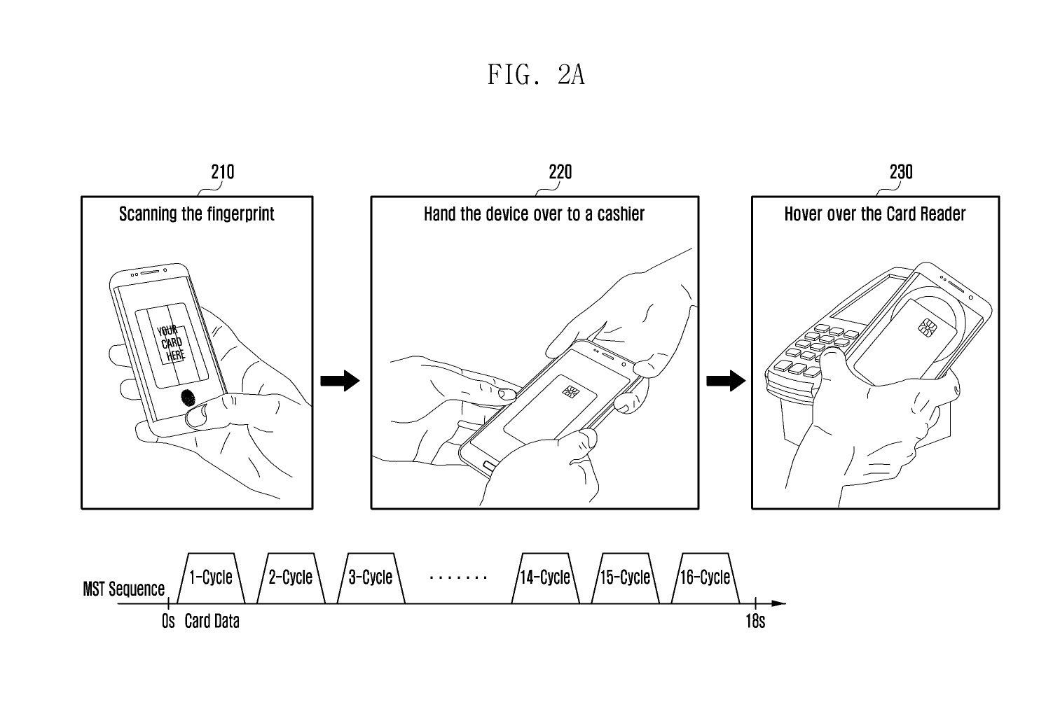

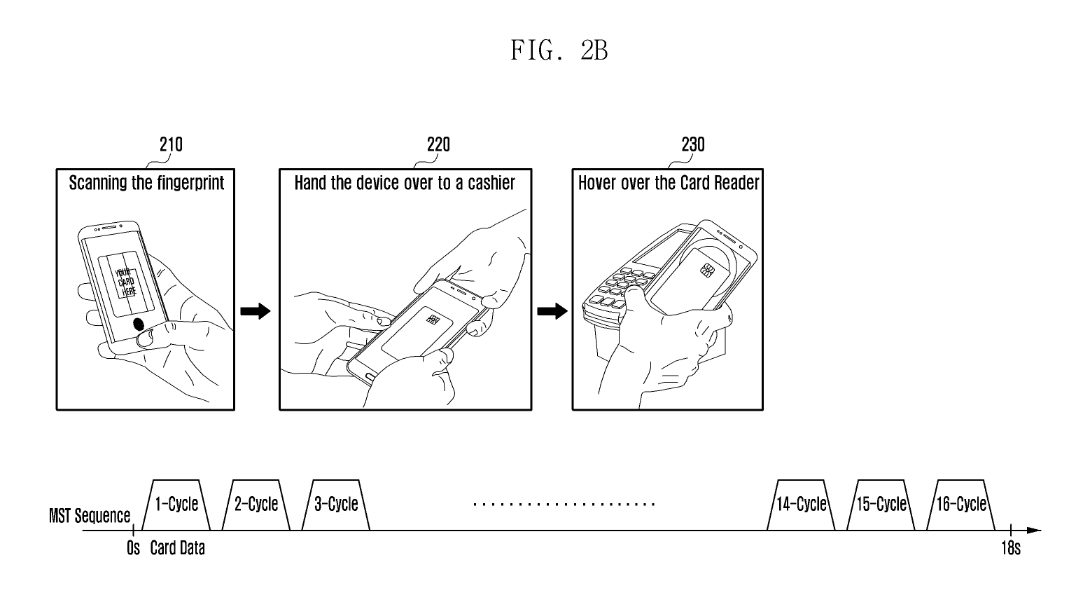

FIGS. 2A and 2B are illustrations of a payment sequence using an electronic device according to an embodiment of the present disclosure.

A procedure for performing a payment function based on an electronic device (e.g., a payment sequence) may be divided into three processes. For example, a procedure for performing a payment function may include a process for authenticating a user via an application for performing a payment function (e.g., fingerprint authentication, password authentication, iris authentication) (operation 1); a process for handing over an electronic device in a process of a payment function to a cashier (e.g., a seller) (operation 2); and a process where the cashier holds the electronic device close to a payment processing device (e.g., a POS terminal, a payment terminal) (operation 3).

If an electronic device performs a user authentication to execute an MST payment function, the electronic device generally generates a magnetic field signal corresponding to the MST payment function via an MST coil from a time of user authentication. The electronic device is capable of repeatedly generating a magnetic field signal a preset number of times for a preset period of time from the time of user authentication.

Referring to FIG. 2A, the electronic device 100 is capable of performing user authentication via fingerprint recognition in step 210. The electronic device 100 is handed over to a cashier in step 220. If the cashier holds the electronic device 100 near a payment processing device (e.g., a POS terminal, a card reader), the electronic device 100 completes the payment function in step 230. The electronic device 100 may be set to repeat the transmission of a magnetic field signal containing card information 16 times for 18 seconds from the time of user authentication. However, the present disclosure is not limited to the number of transmission of a magnetic field signal, the period of time, etc., described above, but may be set according to a manufacturer's design.

The electronic device 100 is capable of repeating the transmission of a magnetic field signal from the time of user authentication as in step 210. The electronic device 100 is capable of stopping the generation of a set of magnetic field signals before the electronic device 100 approaches the payment processing device in step 230. FIG. 2A is an illustration of a case where a time required for payment is greater than a generation time of a magnetic field signal. In this case, the electronic device 100 must repeat the payment sequence to execute the payment function, which causes a user to repeat user authentication, which inconveniences the user.

Referring to FIG. 2B, the electronic device 100 repeats the transmission of a magnetic field signal from the time of user authentication as in step 210. If the electronic device 100 approaches the payment processing device as in step 220, the payment processing device completes the payment as in step 230.

Although the payment processing device has completed the payment, the electronic device 100 may continue to generate a preset magnetic field signal.

FIG. 2B is an illustration of a case where a time required for payment is less than a generation time of a magnetic field signal. In general, if the electronic device 100 receives an acknowledgement (approval) message for the payment completion, the electronic device 100 recognizes that the payment has been completed and stops generating the magnetic field signal. In addition, if the electronic device 100 has not received an acknowledgement (approval) message for the payment completion, the electronic device 100 may continue to generate the preset magnetic field signal. As described above, the electronic device 100 is not capable of intuitively detecting whether payment has been completed. Therefore, the electronic device 100 continues generating a magnetic field signal a preset number of times for a preset period of time.

In general, the electronic device 100 transmits a magnetic field signal via a coil, and consumes a relatively large amount of power for a one-time transmission of the magnetic field signal. Various embodiments of the present disclosure are capable of determining a time to generate a magnetic field signal and a time to stop (or an ending time) generating the magnetic field signal when the electronic device 100 performs a payment function, thereby reducing power consumption in the electronic device 100. For example, the electronic device 100 is capable of generating a magnetic field signal not at a time of user authentication but at a time when the electronic device ascertains that it has approached a payment processing device. The electronic device is capable of considering a time when the payment function has been completed to be an ending time of a magnetic field signal.

Although FIGS. 2A and 2B are described above based on an MST payment mode, the present disclosure is not limited thereto. The present disclosure may perform a payment function with various types of payment modes using coils.

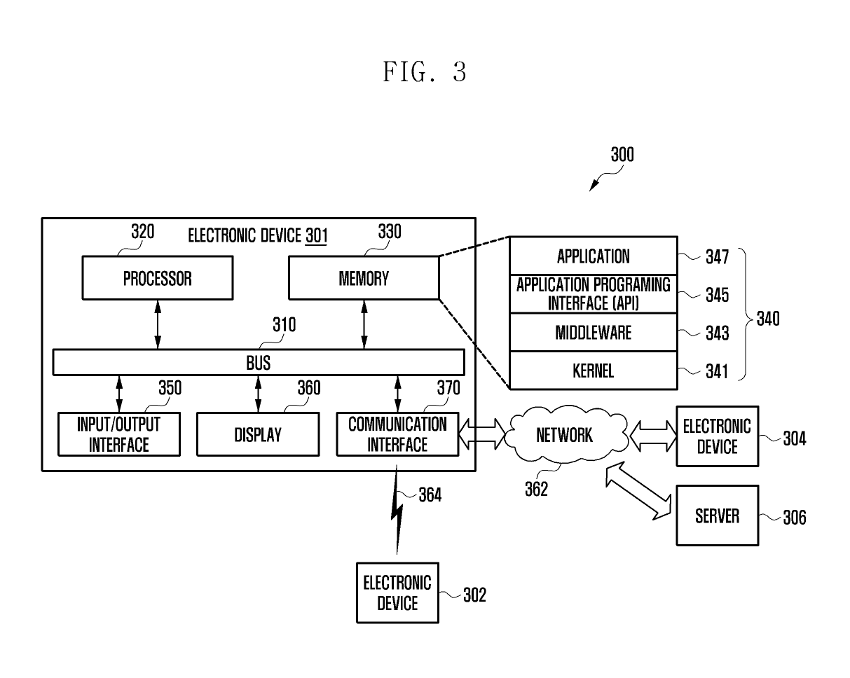

FIG. 3 is a block diagram of an electronic device 301 in a network environment 300 according to an embodiment of the present disclosure.

Referring to FIG. 3, the electronic device 301 may include a bus 310, a processor 320, a memory 330, an input/output interface 350, a display 360, and a communication interface 370. At least one of the above described components may be omitted from the electronic device 301 or another component may be further included in the electronic device 301.

The bus 310 may be a circuit connecting the above described components 320, 330, and 350-370 and transmitting communications (e.g., control messages and/or data) between the above described components.

The processor 320 is capable of including one or more of a CPU, an AP, and a communication processor (CP). The processor 320 is capable of controlling at least one of the other components of the electronic device 301 and/or processing data or operations related to communication.

The memory 330 includes volatile memory and/or non-volatile memory. The memory 330 is capable of storing data or commands related to at least one of other components of the electronic device 301. The memory 330 is capable of storing software and/or a program module 340. For example, the program module 340 includes a kernel 341, middleware 343, an application programming interface (API) 345, an application (application programs or applications) 347, etc. The kernel 341, the middleware 343, or at least a part of the API 345 may be referred to as an operating system (OS).

The kernel 341 is capable of controlling or managing system resources (e.g., the bus 310, the processor 320, the memory 330, etc.) used to execute operations or functions of other programs (e.g., the middleware 343, the API 345, and the application programs 347). The kernel 341 provides an interface capable of allowing the middleware 343, the API 345, and the application programs 347 to access and control/manage the individual components of the electronic device 301.

The middleware 343 is capable of mediating between the API 345 or the application programs 347 and the kernel 341 so that the API 345 or the application programs 347 can communicate with the kernel 341 and exchange data therewith. The middleware 343 is capable of processing one or more task requests received from the application programs 347 according to a priority. For example, the middleware 343 is capable of assigning a priority for using system resources of the electronic device 301 (e.g., the bus 310, the processor 320, the memory 330, etc.) to at least one of the application programs 347. For example, the middleware 343 processes one or more task requests according to a priority assigned to at least one application program, thereby performing scheduling or load balancing for the task requests.

The API 345 refers to an interface configured to allow the application programs 347 to control functions provided by the kernel 341 or the middleware 343. The API 345 includes at least one interface or function (e.g., instructions) for file control, window control, image processing, text control, or the like.

The input/output interface 350 is capable of transferring instructions or data, received from a user or external devices, to one or more components of the electronic device 301. The input/output interface 350 is capable of outputting instructions or data, received from one or more components of the electronic device 301, to a user or external devices.

The display 360 includes a liquid crystal display (LCD), a flexible display, a transparent display, a light emitting diode (LED) display, an organic LED (OLED) display, micro-electro mechanical systems (MEMS) display, an electronic paper display, etc. The display 360 is capable of displaying various types of content (e.g., texts, images, videos, icons, symbols, etc.). The display 360 may also be implemented with a touch screen. In this case, the display 360 is capable of receiving touches, gestures, proximity inputs or hovering inputs, via a stylus pen, or a part of a user's body.

The communication interface 370 is capable of establishing communication between the electronic device 301 and an external device (e.g., a first external device 302, a second electronic device 304, or a server 306). For example, the communication interface 370 is capable of communicating with the second external device 304 or the server 306 connected to the network 362 via wired or wireless communication.

Wireless communication may employ, as a cellular communication protocol, at least one of the following: long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM). Wireless communication may also include short-range wireless communication 364. Short-range wireless communication 364 may include at least one of the following: wireless fidelity (Wi-Fi), Bluetooth (BT), NFC, MST, and global navigation satellite system (GNSS). The GNSS may include at least one of the following: GPS, global navigation satellite system (Glonass), Beidou navigation satellite system (Beidou), Galileo, the European global satellite-based navigation system, according to GNSS using areas, bandwidths, etc. In the present disclosure, “GPS” and “GNSS” may be used interchangeably. Wired communication may include at least one of the following: universal serial bus (USB), high definition multimedia interface (HDMI), recommended standard 232 (RS-232), and plain old telephone service (POTS). The network 362 may include at least one of the following: a telecommunications network, e.g., a computer network (e.g., a local area network (LAN) or a wide area network (WAN)), the Internet, and a telephone network.

The first and second external electronic devices 302 and 304 are each identical to or different from the electronic device 301, in terms of type. The server 306 is capable of including a group of one or more servers. A part or all of the operations executed on the electronic device 301 may be executed on another electronic device or a plurality of other electronic devices (e.g., electronic devices 302 and 304 or the server 306). If the electronic device 301 must perform a function or service automatically or according to a request, the electronic device 301 does not have to perform the function or service, but is capable of additionally requesting at least a part of the function related to the function or service from another electronic device (e.g., electronic devices 302 and 304 or the server 306). The other electronic device (e.g., electronic devices 302 and 304 or the server 306) is capable of executing the requested function or additional functions, and transmitting the result to the electronic device 301. The electronic device 301 processes the received result, or further proceeds with additional processes, to provide the requested function or service. To this end, the electronic device 301 may employ cloud computing, distributed computing, or client-server computing technology.

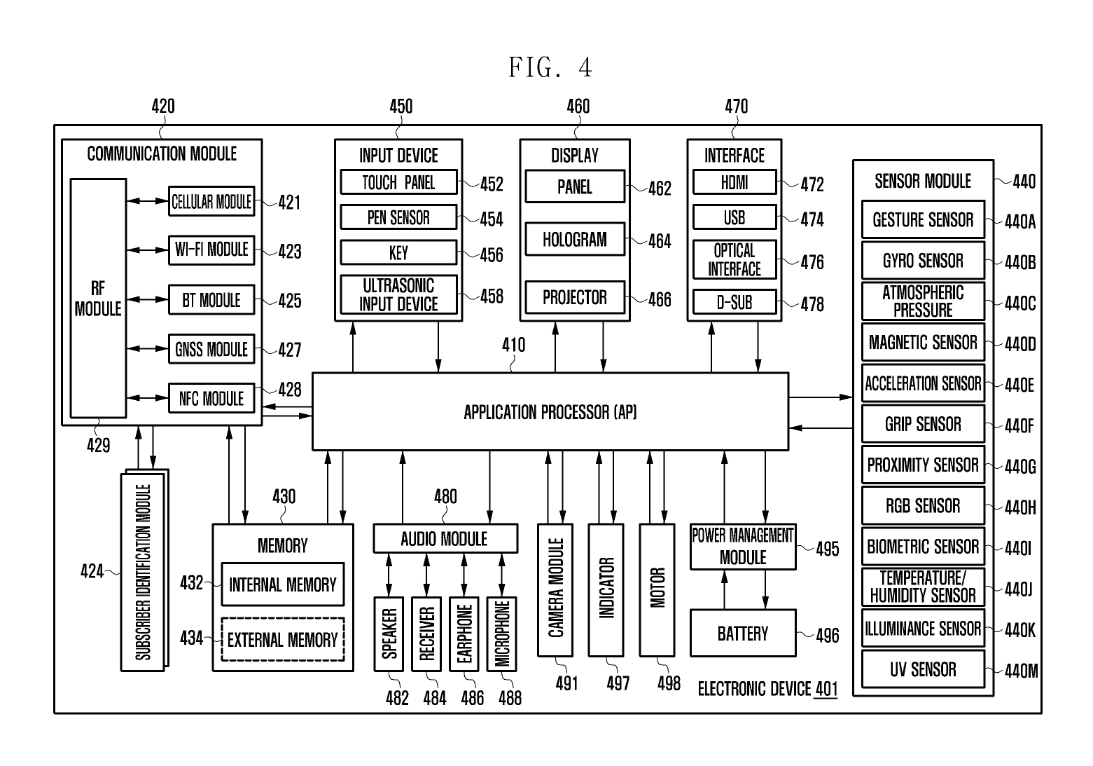

FIG. 4 is a block diagram of an electronic device 401 according to an embodiment of the present disclosure.

Referring to FIG. 4, the electronic device 401 is capable of including part or all of the components in the electronic device 301 shown in FIG. 3 and described above. The electronic device 401 is capable of including one or more of an application processor 410 (e.g., APs), a communication module 420, a subscriber identification module (SIM) 424, a memory 430, a sensor module 440, an input device 450, a display 460, an interface 470, an audio module 480, a camera module 491, a power management module 495, a battery 496, an indicator 497, and a motor 498.

The application processor 410 is capable of driving, for example, an operating system or an application program to control a plurality of hardware or software components connected to the application processor 410, processing various data, and performing operations. The application processor 410 may be implemented as, for example, a system on chip (SoC). The application processor 410 may further include a graphics processing unit (GPU) and/or an image signal processor (ISP). The application processor 410 may also include at least a part of the components shown in FIG. 4, e.g., a cellular module 421. The application processor 410 is capable of loading commands or data received from at least one of the other components (e.g., a non-volatile memory) on a volatile memory, and processing the loaded commands or data. The application processor 410 is capable of storing various data in a non-volatile memory.

The communication module 420 may include the same or similar configurations as the communication interface 370 shown in FIG. 3 and described above. For example, the communication module 420 is capable of including the cellular module 421, a Wi-Fi module 423, a BT module 425, a GNSS module 427 (e.g., a GPS module, a Glonass module, a Beidou module or a Galileo module), an NFC module 428, and a radio frequency (RF) module 429.

The cellular module 421 is capable of providing a voice call, a video call, a short message service (SMS) service, an Internet service, etc., through a communication network, for example. The cellular module 421 is capable of identifying and authenticating an electronic device 401 in a communication network by using the SIM 424 (e.g., a SIM card). The cellular module 421 is capable of performing at least a part of the functions provided by the application processor 410. The cellular module 421 is also capable of including a CP.

Each of the Wi-Fi module 423, the BT module 425, the GNSS module 427, and the NFC module 428 is capable of including a processor for processing data transmitted or received through the corresponding module. At least part of the cellular module 421, the Wi-Fi module 423, the BT module 425, the GNSS module 427, and the NFC module 428 (e.g., two or more modules) may be included in one integrated circuit or chip (IC) or one IC package.

The RF module 429 is capable of transmission/reception of communication signals, e.g., RF signals. The RF module 429 is capable of including a transceiver, a power amplifier module (PAM), a frequency filter, a low noise amplifier (LNA), an antenna, etc. At least one of the following modules: the cellular module 421, the Wi-Fi module 423, the BT module 425, the GNSS module 427, and the NFC module 428 is capable of transmission/reception of RF signals through a separate RF module.

The SIM module 424 is capable of including a SIM card and/or an embodied SIM. The SIM module 424 is also capable of containing unique identification information, e.g., an integrated circuit card identifier (ICCID), or subscriber information, e.g., an international mobile subscriber identity (IMSI).

The memory 430 (e.g., the memory 330 shown in FIG. 3 and described above) is capable of including an internal or built-in memory 432 or an external memory 434. The built-in memory 432 is capable of including at least one of the following: a volatile memory, e.g., a dynamic random access memory (DRAM), a static RAM (SRAM), a synchronous DRAM (SDRAM), etc.; and a non-volatile memory, e.g., a one-time programmable read-only memory (OTPROM), a programmable ROM (PROM), an erasable PROM (EPROM), an electrically erasable PROM (EEPROM), a mask ROM, a flash ROM, a flash memory (e.g., a NAND flash memory, an NOR flash memory, etc.), a hard drive, a solid state drive (SSD), etc.

The external memory 434 is also capable of including a flash drive, e.g., a compact flash (CF), a secure digital (SD) card, a micro secure digital (micro-SD) card, a mini secure digital (mini-SD), an extreme digital (xD) card, a multi-media card (MMC), a memory stick, etc. The external memory 434 is capable of being connected to the electronic device 401, functionally and/or physically, through various interfaces.

The sensor module 440 is capable of measuring/detecting a physical quantity or an operation state of the electronic device 401 and converting the measured or detected information into an electrical signal. The sensor module 440 is capable of including at least one of the following: a gesture sensor 440A, a gyro sensor 440B, an atmospheric pressure sensor 440C, a magnetic sensor 440D, an acceleration sensor 440E, a grip sensor 440F, a proximity sensor 440G, a color sensor 440H (e.g., a red, green and blue (RGB) sensor), a biometric sensor 440I, a temperature/humidity sensor 440J, an illuminance sensor 440K, and a ultraviolet (UV) light sensor 440M. Additionally or alternatively, the sensor module 440 is capable of further including an electronic-nose (E-nose) sensor, an electromyography (EMG) sensor, an electroencephalogram (EEG) sensor, an electrocardiogram (ECG) sensor, an infrared (IR) sensor, an iris sensor and/or a fingerprint sensor. The sensor module 440 is capable of further including a control circuit for controlling one or more sensors included therein. The electronic device 401 is capable of including a processor, configured as part of the application processor 410 or a separate component, for controlling the sensor module 440. In this case, while the application processor 410 is operating in reduced power or sleep mode, the processor is capable of controlling the sensor module 440.

The input device 450 is capable of including a touch panel 452, a (digital) pen sensor 454, a key 456, or an ultrasonic input device 458. The touch panel 452 may be implemented with at least one of a capacitive touch system, a resistive touch system, an infrared touch system, and an ultrasonic touch system. The touch panel 452 may further include a control circuit. The touch panel 452 may also further include a tactile layer to provide a tactile response to the user.

The (digital) pen sensor 454 may be implemented with a part of the touch panel or with a separate recognition sheet. The key 456 may include a physical button, an optical key, or a keypad. The ultrasonic input device 458 is capable of detecting ultrasonic waves, created in an input tool, through a microphone 488, and identifying data corresponding to the detected ultrasonic waves.

The display 460 (e.g., the display 360 shown in FIG. 3 and described above) is capable of including a panel 462, a hologram 464, or a projector 466. The panel 462 may include the same or similar configurations as the display 360 shown in FIG. 3 and described above. The panel 462 may be implemented to be flexible, transparent, or wearable. The panel 462 may also be incorporated into one module together with the touch panel 452. The hologram 464 is capable of showing a stereoscopic image in the air by using the interference of light. The projector 466 is capable of displaying an image by projecting light onto a screen. The screen may be located inside or outside of the electronic device 401. The display 460 may further include a control circuit for controlling the panel 462, the hologram 464, or the projector 466.

The interface 470 is capable of including a high-definition multimedia interface (HDMI) 472, a USB 474, an optical interface 476, or a D-subminiature (D-sub) connector 478. The interface 470 may be included in the communication interface 370 shown in FIG. 3 and described above. Additionally or alternatively, the interface 470 is capable of including a mobile high-definition link (MHL) interface, an SD card/MMC interface, or an Infrared Data Association (IrDA) standard interface.

The audio module 480 is capable of providing bidirectional conversion between a sound and an electrical signal. At least a part of the components in the audio module 480 may be included in the input/output interface 350 shown in FIG. 3 and described above. The audio module 480 is capable of processing sound information input or output through a speaker 482, a receiver 484, an earphone 486, the microphone 488, etc.

The camera module 491 refers to a device capable of taking both still and moving images. The camera module 491 is capable of including one or more image sensors (e.g., a front image sensor or a rear image sensor), a lens, an ISP, a flash (e.g., an LED or a xenon lamp), etc.

The power management module 495 is capable of managing power of the electronic device 401. The power management module 495 is capable of including a power management integrated circuit (PMIC), a charger IC, or a battery gauge. The PMIC may employ wired charging and/or wireless charging methods. Examples of a wireless charging method include magnetic resonance charging, magnetic induction charging, and electromagnetic charging. To this end, the PIMC may further include an additional circuit for wireless charging, such as a coil loop, a resonance circuit, a rectifier, etc. The battery gauge is capable of measuring the residual capacity, charge in voltage, current, or temperature of the battery 496. The battery 496 may take the form of either a rechargeable battery or a solar battery.

The indicator 497 is capable of displaying a certain status of the electronic device 401 or a part thereof (e.g., the application processor 410), e.g., a boot-up status, a message status, a charging status, etc. The motor 498 is capable of converting an electrical signal into mechanical vibrations, such as, a vibration effect, a haptic effect, etc. The electronic device 401 is capable of further including a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or mediaFlo™, etc.

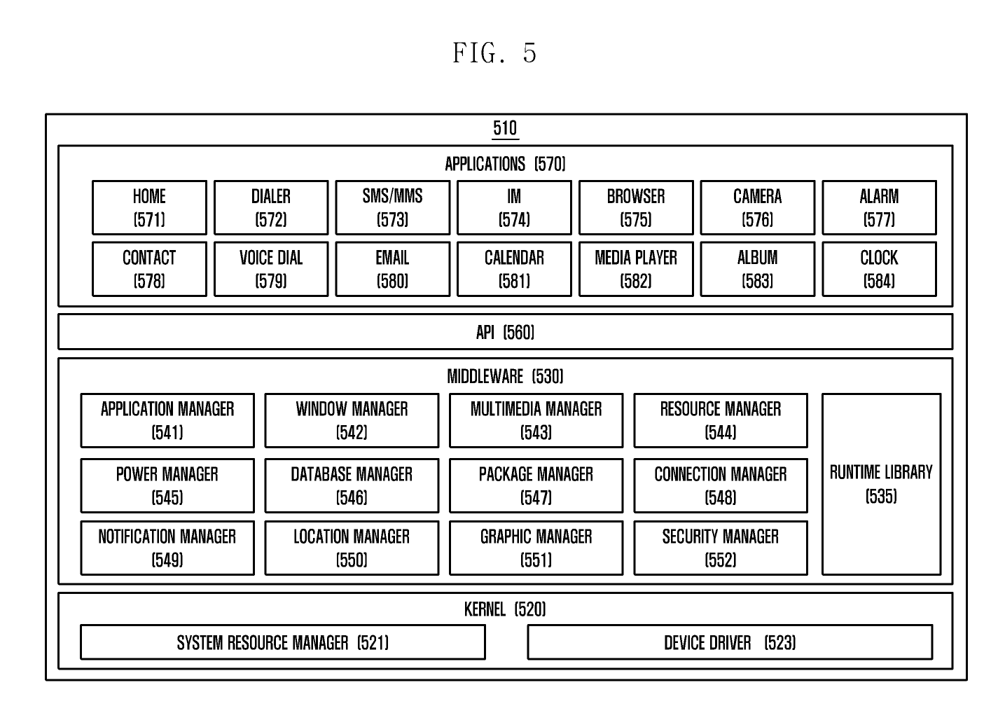

FIG. 5 is a block diagram of a programming module according to an embodiment of the present disclosure.

Referring to FIG. 5, the program module 510 (e.g., program module 340 shown in FIG. 3 and described above) is capable of including an OS for controlling resources related to the electronic device (e.g., electronic device 301 shown in FIG. 3 and described above) and/or various applications (e.g., application programs 347 shown in FIG. 3 and described above) running on the OS. The OS may be Android®, iOS®, Windows®, Symbian®, Tizen®, Bada™, etc.

The program module 510 is capable of including a kernel 520, middleware 530, an API 560 and/or applications 570. At least a part of the program module 510 may be preloaded onto the electronic device device 302 or 304 or downloaded from the server 306.

The kernel 520 (for example, kernel 341 shown in FIG. 3 and described above) may include a system resource manager 521 and/or a device driver 523. The system resource manager 521 may include, for example, a process manager, a memory manager, and a file system manager. The system resource manager 521 may perform a system resource control, allocation, and recall. The device driver 523 may include, for example, a display driver, a camera driver, a BT driver, a shared memory driver, a USB driver, a keypad driver, a Wi-Fi driver, and an audio driver. Further, the device driver 523 may include an Inter-Process Communication (IPC) driver.

The middleware 530 may provide a function required in common by the applications 570. Further, the middleware 530 may provide a function through the API 560 to allow the applications 570 to efficiently use limited system resources within the electronic device. The middleware 530 (for example, the middleware 343 shown in FIG. 3 and described above) may include at least one of a runtime library 535, an application manager 541, a window manager 542, a multimedia manager 543, a resource manager 544, a power manager 545, a database manager 546, a package manager 547, a connection manager 548, a notification manager 549, a location manager 550, a graphic manager 551, and a security manager 552.

The runtime library 535 may include, for example, a library module used by a complier to add a new function through a programming language while the applications 570 are executed. The runtime library 535 executes input and output, management of a memory, a function associated with an arithmetic function and the like.

The application manager 541 may manage, for example, a life cycle of at least one of the applications 570. The window manager 542 may manage graphical user interface (GUI) resources used on a screen. The multimedia manager 543 may detect a format required for reproducing various media files and perform an encoding or a decoding of a media file by using a codec suitable for the corresponding format. The resource manager 544 manages resources such as source code, a memory, or a storage space of at least one of the applications 570.

The power manager 545 may operate together with a basic input/output system (BIOS) to manage a battery or power and provides power information required for the operation. The database manager 546 may manage generation, search, and change of a database to be used by at least one of the applications 570. The package manager 547 may manage an installation or an update of an application distributed in a form of a package file.

The connection manager 548 may manage, for example, a wireless connection such as Wi-Fi or BT. The notification manager 549 may display or notify a user of an event such as an arrival of a message, an appointment, a proximity alarm or the like, in a manner that does not disturb the user. The location manager 550 may manage location information of the electronic device. The graphic manager 551 may manage a graphic effect provided to the user or a user interface related to the graphic effect. The security manager 552 provides a general security function required for system security or user authentication. If the electronic device (for example, the electronic device 301 shown in FIG. 3 and described above) has a call function, the middleware 530 may further include a telephony manager for managing a voice call of the electronic device or a video call function.

The middleware 530 is capable of including modules configuring various combinations of functions of the above described components. The middleware 530 is capable of providing modules specialized according to types of operating systems to provide distinct functions. The middleware 530 may be adaptively configured in such a way as to remove a part of the existing components or to include new components.

The API 560 (for example, the API 345 shown in FIG. 3 and described above) may be a set of API programming functions, and may be provided with a different configuration according to an operating system. For example, in Android® or iOS®, a single API set may be provided for each platform. In Tizen®, two or more API sets may be provided.

The applications 570 (e.g., application programs 347 shown in FIG. 3 and described above) may include one or more applications for performing various functions, e.g., a home application 571, a dialer application 572, an SMS/multimedia messaging service (MMS) application 573, an instant messaging (IM) application 574, a browser application 575, a camera application 576, an alarm application 577, a contact application 578, a voice dial application 579, an email application 580, a calendar application 581, a media player application 582, an album application 583, a clock application 584, a health care application (e.g., an application for measuring an amount of exercise, a blood sugar level, etc.), and an environmental information application (e.g., an application for providing atmospheric pressure, humidity, temperature, etc.).

According to an embodiment of the present disclosure, the applications 570 are capable of including an application for supporting information exchange between an electronic device (e.g., the electronic device 301 shown in FIG. 3 and described above) and electronic devices 302 and 304, (e.g., an information exchange application)). The information exchange application is capable of including a notification relay application for relaying certain information to external devices or a device management application for managing external devices.

For example, the notification relay application is capable of including a function for relaying notification information created in other applications of the electronic device (e.g., the SMS/MMS application 573, the email application 580, the health care application, the environmental information application, etc.) to electronic devices 302 and 304. In addition, the notification relay application is capable of receiving notification information from external devices to provide the received information to a user.

The device management application is capable of managing (e.g., installing, removing or updating) at least one function of the electronic devices 302 and 304 communicating with the electronic device. Examples of the function are a function of turning-on/off the external device or a part of the external device, a function of controlling the brightness (or resolution) of a display, applications running on the external device, services provided by the external device, etc. Examples of the services are a call service, a messaging service, etc.

According to an embodiment of the present disclosure, the applications 570 are capable of including an application (e.g., a health care application of a mobile medical device, etc.) specified attributes of an external device (e.g., electronic devices 302 and 304). The applications 570 are capable of including applications received from the server 306, the electronic devices 302 and 304, etc. The applications 570 are capable of including a preloaded application or third party applications that may be downloaded from a server. The components of the program module 510 may be referred to by different names according to the type of operating system.

According to various embodiments of the present disclosure, at least a part of the program module 510 may be implemented with software, firmware, hardware, or any combination of two or more of them. At least a part of the program module 510 may be implemented (e.g., executed) by a processor (e.g., the application processor 410 shown in FIG. 4 and described above). At least a part of the programing module 510 may include modules, programs, routines, sets of instructions or processes, etc., in order to perform one or more functions.

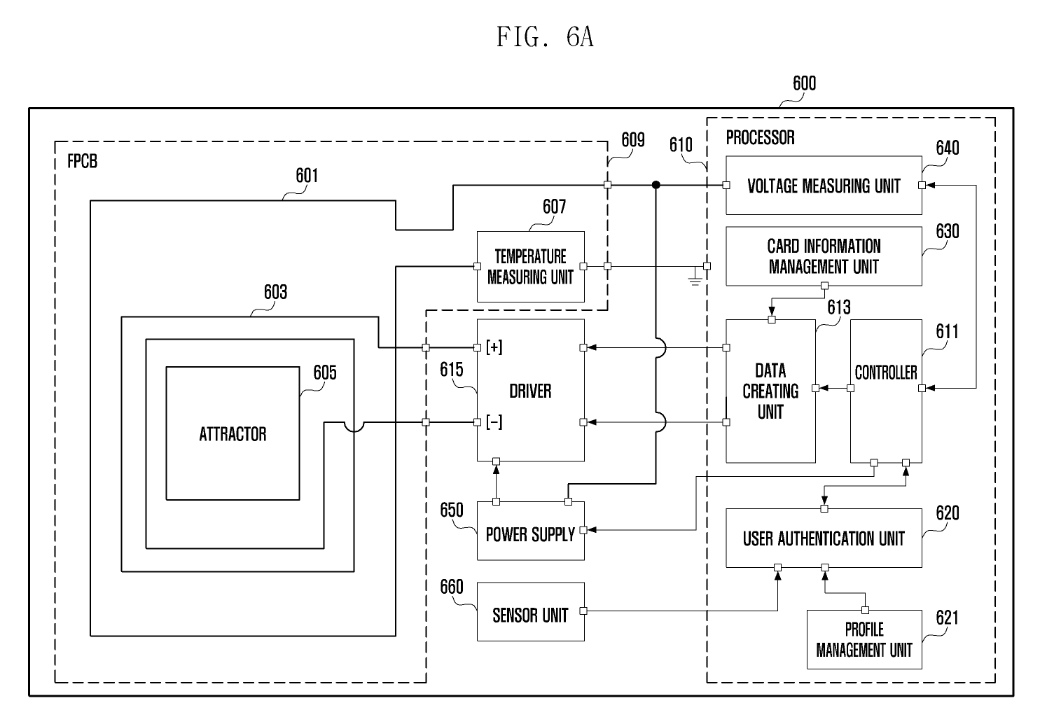

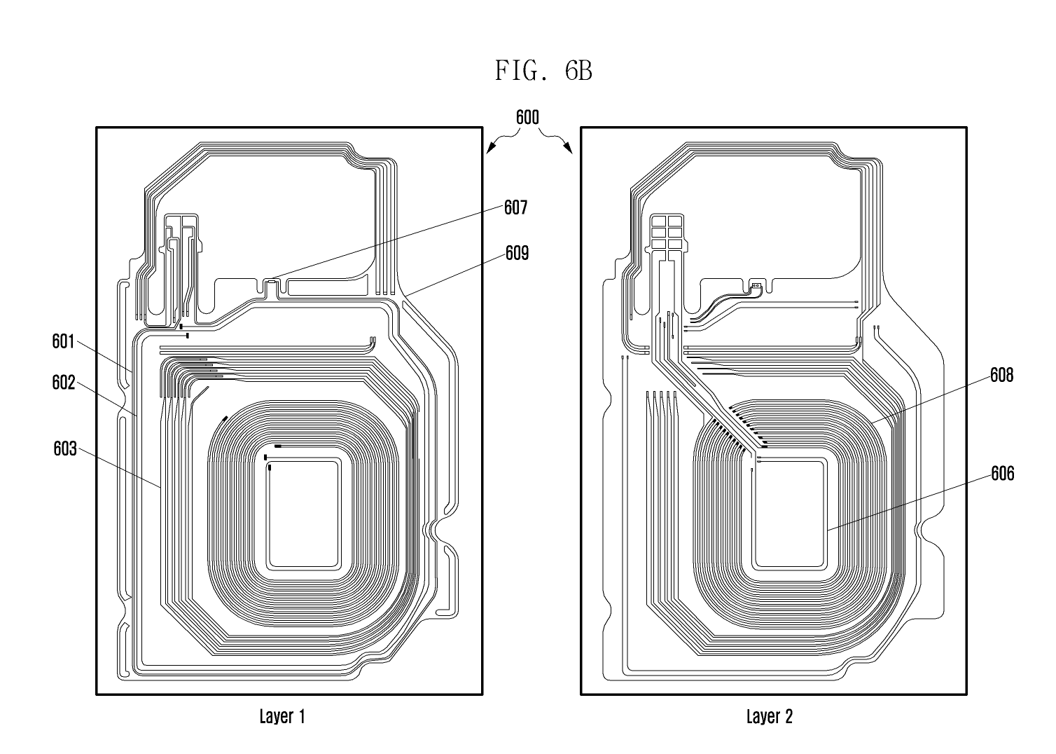

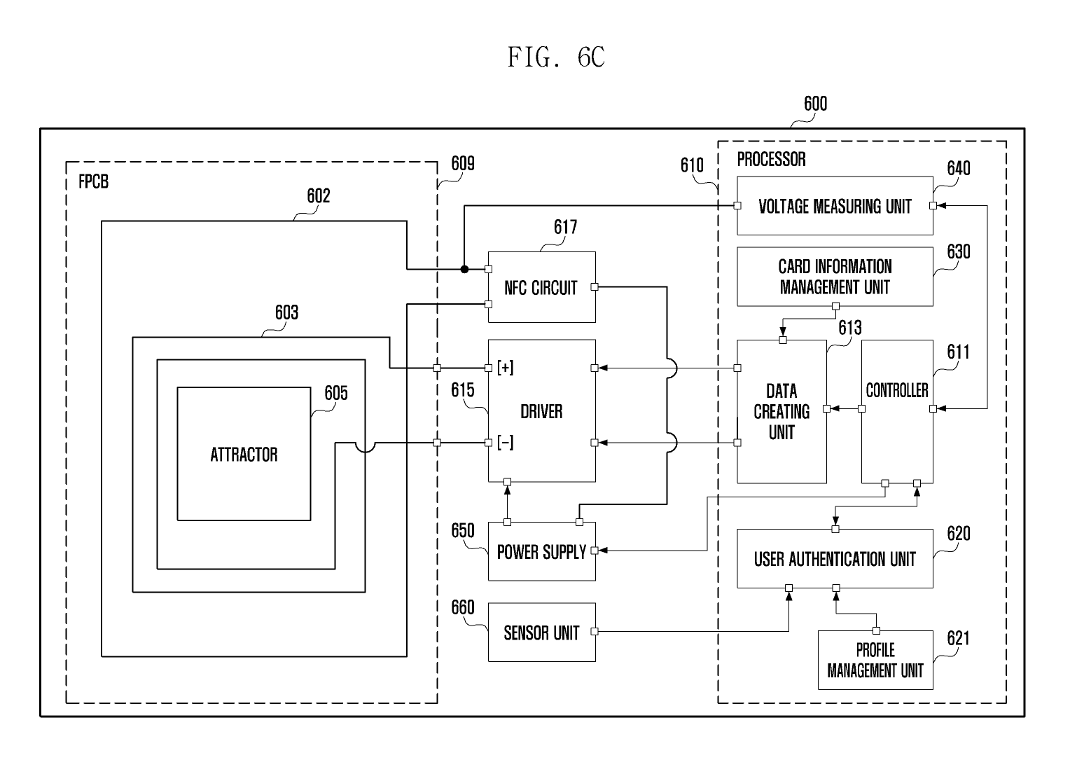

FIGS. 6A, 6B, and 6C are diagrams of an electronic device 600 which determines whether an electronic device approaches a payment processing device and performs a payment function according to an embodiment of the present disclosure.

Referring to FIG. 6A, the electronic device 600 (e.g., the electronic device 301 shown in FIG. 3 and described above) is capable of including a number of components (e.g., a processor 610, a driver 615, an FPCB 609, a power supply 650, and a sensor unit 660). The electronic device 600 is capable of controlling coils included in the FPCB 609 via the processor 610.

The FPCB 609 is capable of including a number of coils. For example, the FPCB 609 is capable of including a voltage detecting coil 601 for measuring an ambient voltage of the electronic device 600 and an MST coil 603 for supporting an MST payment mode. The FPCB 609 is also capable of including an NFC coil for supporting an NFC payment mode. In the following description, the voltage detecting coil 601 is referred to as a first coil, and the MST coil 603 is referred to as a second coil. The first coil is not limited in type to the voltage detecting coil 601. The second coil is not limited in type to the MST coil 603.

The voltage detecting coil 601 is capable of detecting magnetic fields generated in the vicinity of the electronic device 600. The processor 610 is capable of detecting an ambient magnetic field of the electronic device 600 via the voltage detecting coil 601, and measuring the magnitude of voltage corresponding to the magnetic field via a voltage measuring unit 640. The FPCB 609 is capable of measuring a temperature of the electronic device 600 via a temperature measuring unit 607 (e.g., a thermistor 109 shown in FIG. 1 and described above) connected to the voltage detecting coil 601.

The second coil (e.g., the MST coil 603) is capable of including a coil antenna for supporting a first payment mode (e.g., an MST payment mode). The second coil 603 is capable of receiving an electrical signal, transferred from a data creating unit 613 of the processor 610 to a driver 615, and converting the received electrical signal into a magnetic field signal. The driver 615 may be implemented with a charge-pump circuit, an over-voltage protection (OVP) circuit, etc. The OVP circuit is capable of blocking an overvoltage, thereby preventing an overcurrent from flowing. The driver 615 receives current from the power supply 650. The processor 610 supplies current to the MST coil 603, thereby converting the current into a magnetic field signal. The MST coil 603 is capable of creating a magnetic field signal corresponding to the MST payment mode.

The first coil (e.g., the voltage detecting coil) 601 and the second coil (e.g., the MST coil) 603 are physically adjacent to each other. The electronic device 600 is capable of measuring its temperature via a temperature measuring unit 607 connected to the voltage detecting coil 601, and its ambient magnetic field via the voltage detecting coil 601. For example, if the electronic device 600 performs a payment function, it blocks power applied to the voltage detecting coil 601, and detects an ambient magnetic field via the voltage detecting coil 601. That is, the electronic device 600 is capable of detecting a magnetic field generated from a payment processing device near the electronic device 600. The payment processing device includes a magnetic header for reading a magnetic card. The magnetic header operates in an idle mode to read a magnetic card. The magnetic header in an idle mode may generate a weak magnetic field. That is, the payment processing device may generate a magnetic field corresponding to a weak magnetic field of the magnetic header. The electronic device 600 is capable of detecting a magnetic field from the payment processing device via the first coil, and measuring the magnitude of induced electromotive force (e.g., induced voltage) corresponding to the magnetic field. The electronic device 600 is capable of performing a payment function corresponding to the second coil 603 based on the measured induced electromotive force.

The FPCB 609 is capable of including an attractor 605 for amplifying a magnetic field generated from the payment processing device. The attractor 605 is made of ferrite and a metal. The attractor 605 may be implemented with a magnetic body. The attractor 605 may be disposed adjacent to the voltage detecting coil 601 so that the detecting coil may easily detect an amplified magnetic field. The FPCB 609 may also include a WPC coil for performing a wireless charging function. The FPCB 609 may include a coil and a configuration unit. However, the FPCB 609 is not limited to the coil and the configuration unit shown in FIGS. 6A, 6B, and 6C.

The processor 610 is capable of including a controller 611, the data creating unit 613, a user authentication unit 620, a profile management unit 621, a card information management unit 630, and a voltage measuring unit 640 (e.g., an analog-to-digital converter (ADC)). The processor 610 is capable of controlling the components described above via the controller 611. The processor 610 is capable of controlling coils included in the FPCB 609 via other components which are not included in the processor 610.

The controller 611 is capable of authenticating a user via the user authentication unit 620 under control of the processor 610. The controller 611 is capable of detecting a magnetic field generated by a payment processing device via the voltage detecting coil 601, and measuring a magnitude of an induced voltage (e.g., an induced electromotive force) corresponding to the detected magnetic field via the voltage measuring unit 640. The controller 611 is capable of determining whether the electronic device 600 approaches a payment processing device, based on the measured induced voltage. If the controller 611 determines that the electronic device 600 approaches the payment processing device, the controller 611 is capable of controlling the data creating unit 613 to create data required to perform a payment function. The controller 611 is capable of transmitting the created data to the payment processing device via the second coil (e.g., the MST coil) 603 included in the FPCB 609. The controller 611 is capable of controlling operations to perform a payment function under the control of the processor 610.

The data creating unit 613 is capable of controlling the direction of current flowing into the MST coil 603 by applying a voltage with different polarities to the two ends of the MST coil 603 according to data (e.g., a 0 or 1 bit). The data creating unit 613 is capable of receiving data containing card information from the card information management unit 630 and converting the data into a pulse signal of a logical low/high. The data creating unit 613 is capable of transferring the converted pulse signal to the MST coil 603 via the driver 615. The driver 615 may include an H-bridge for controlling the polarity of a voltage applied to the two ends of the MST coil 603.

The user authentication unit 620 is capable of authenticating a user, based on the user information received via the profile management unit 621. For example, the user authentication unit 620 is capable of receiving information regarding the user authentication (e.g., fingerprint recognition, facial recognition, iris recognition, password verification, etc.) to perform a payment function, and authenticating the user via a profile stored in the profile management unit 621. The controller 611 is capable of determining whether a user is authenticated via the user authentication unit 620.

The profile management unit 621 is capable of storing information related to user authentication. For example, the profile management unit 621 is capable of storing a user's fingerprint information, face information, iris information, etc. The profile management unit 621 is capable of altering stored information. The profile management unit 621 is capable of encrypting and storing information. The profile management unit 621 may be included in a memory (e.g., the memory 330 shown in FIG. 3 and described above).

The card information management unit 630 is capable of storing card information to perform a payment function. Examples of the card information are a card number, a card expiry date, a pin number, a user name, a card validation code (CVC) number, etc. The card information management unit 630 is capable of storing card details. If the user authentication unit 620 authenticates a user, the controller 611 checks information regarding the authenticated user from the card information management unit 630. The card information management unit 630 may be classified into a subscriber identification module (e.g., the subscriber identification module 424 shown in FIG. 4 and described above), instead of the processor 610. The electronic device 600 is capable of receiving card information (e.g., track 1, track 2, track 3 or token information) included in at least a part of a magnetic stripe of a card (e.g., a magnetic card) from a card issuing company or bank server via a communication module. The processor 610 is capable of processing and storing card information in a corresponding form in the card information management unit 630 or a separate built-in secure module, e.g., a SIM.

The voltage measuring unit 640 is capable of measuring induced electromotive force corresponding to a magnetic field signal generated in a payment processing device (e.g., another electronic device). For example, the voltage measuring unit 640 is capable of converting a magnetic field signal generated in a payment processing device into an induced electromotive force and measuring the induced electromotive force by using a voltage detecting coil. The processor 610 is capable of detecting the distance between the electronic device 600 and the payment processing device based on the measured induced electromotive force.

The power supply 650 is capable of supplying power to components in the electronic device 600. The power supply 650 is capable of supplying power to the NFC coil 603. If a temperature is measured via the NFC coil 603, the power supply 650 is capable of applying a default level of voltage required to measure the temperature to the NFC coil 603. In this case, the power supply 650 may be in a pull-up state. If an induced electromotive force for a payment processing device is measured by using the NFC coil 603, the power supply 650 is capable of switching the state of power applied to the NFC coil 603 from a current state to a pull-down state. If the power supply 650 is connected to an NFC circuit to perform an NFC payment based on the NFC coil 603, the power supply 650 is capable of maintaining a pull-up state to perform an NFC payment. If an induced electromotive force for a payment processing device is measured via the NFC coil 603, the power supply 650 is capable of switching a current state to a pull-down state.

The sensor unit 660 (e.g., the sensor module 240 shown in FIG. 2 and described above) is capable of sensing a user's fingerprint, iris, etc. to perform user authentication. The electronic device 600 receives an input value corresponding to a user's fingerprint, iris, etc. from the sensor unit 660, and performs user authentication based on the input value.

FIG. 6B shows part of the components shown in FIG. 6A.

With reference to FIG. 6B, the electronic device 600 may dispose a number of coils on the FPCB 609, in layers, e.g., Layer 1 and Layer 2. Layer 1 and Layer 2 may be adjacently disposed on the front and rear sides of the electronic device 600. Layer 1 and Layer 2 are electrically connected to each other.

The electronic device 600 may arrange a voltage detecting coil 601, an NFC coil 602, an MST coil 603, and a temperature measuring module (e.g., a thermistor, a temperature measuring unit 607 shown in FIG. 6A and described above) in the FPCB 609. The voltage detecting coil 601 is capable of measuring a temperature of the electronic device 600 via the temperature measuring unit 607 or detecting an ambient magnetic field of the electronic device 600. If the electronic device 600 operates in an NFC payment mode, the NFC coil 602 is capable of generating a magnetic field corresponding to the NFC payment mode, and detecting an ambient magnetic field of the electronic device 600. If the electronic device 600 operates in an MST payment mode, the MST coil 603 is capable of generating a magnetic field corresponding to the

MST payment mode.

The electronic device 600 may arrange an NFC coil 606 and a wireless charging coil 608 (e.g., the third coil 108 shown in FIG. 1 and described above, e.g., a WPC coil) in the FPCB 609. The NFC coil 606 may be arranged in each of Layer 1 and Layer 2 so that Layer 1 and Layer 2 may create a magnetic field corresponding to the

NFC payment mode and detect an ambient magnetic field of the electronic device 600. The wireless charging coil 608 is capable of charging a battery of the electronic device 600 (e.g., the battery 496 shown in FIG. 4 and described above) in a wireless mode.

FIG. 6C is a diagram of an electronic device 600 configured to detect an ambient magnetic field of the electronic device 600 by using the NFC coil 602 of the FPCB 609.

The electronic device 600 shown in FIG. 6C is similar to that shown in FIG. 6A in terms of components, except that the electronic device 600 shown in FIG. 6C includes an NFC coil 602 serving as the voltage detecting coil 601 and an NFC circuit 617 serving as the temperature measuring unit 607.

The NFC coil 602 is capable of including a coil antenna connected to the NFC circuit 617 configured to support a second payment mode (e.g., an NFC payment mode). The NFC coil 602 is referred to as a coil (e.g., a loop antenna) for supporting an NFC payment mode. Like the voltage detecting coil 601 shown in FIG. 6A and described above, the NFC coil 602 is capable of detecting an ambient magnetic field of the electronic device 600. For example, the processor 610 is capable of detecting an ambient magnetic field of the electronic device 600 via the NFC coil 602, and measuring induced electromotive force corresponding to the detected magnetic field. The electronic device 600 is capable of detecting its ambient magnetic field via one of a number of coils installed thereto. The electronic device 600 is capable of detecting its ambient magnetic field via one of a number of coils installed thereto which has a relatively small resistance and a relatively small inductance.

In various embodiments of the present disclosure, the electronic device 600 is capable of supporting an NFC payment mode via the NFC coil 602. For example, the electronic device 600 is capable of blocking power applied to the NFC coil 602, and detecting its ambient magnetic field via the NFC coil 602. If the electronic device 600 detects a magnetic field, it is capable of measuring an induced voltage based on the detected magnetic field, and determining a type of payment mode based on the measured induced voltage. If a payment mode is determined as an NFC payment mode, the electronic device 600 applies power to the NFC coil 602, and generates a magnetic field corresponding to the NFC payment mode via the NFC circuit 617. The electronic device 600 is capable of detecting its ambient magnetic field via the NFC coil 602 and generating a magnetic field corresponding to the NFC payment mode.

In various embodiments of the present disclosure, a mobile electronic device is configured in such a way as to include a PCB which is built in a central area of the mobile electronic device and includes a first loop antenna and/or a second loop antenna; a processor electrically connected to the first loop antenna and the second loop antenna; and a memory electrically connected to the processor, for storing card information related to payment. The processor determines whether the mobile electronic device is close to an external payment terminal, using the first loop antenna; and generates, if the mobile electronic device is close to an external payment terminal, a magnetic field signal including the card information, via the first loop antenna and/or the second loop antenna, in response to a payment command.

In various embodiments of the present disclosure, the processor activates a magnetic field detection function for the first loop antenna in order to detect an ambient magnetic field; detects a magnetic field generated from the payment terminal, using the first loop antenna; determines whether an induced voltage corresponding to the detected magnetic field is greater than a first reference voltage; and ascertains that the mobile electronic device is close to the payment terminal if an induced voltage is greater than a first reference voltage.

In various embodiments of the present disclosure, the electronic device further includes an attractor, built in the electronic device and located close to the first loop antenna, for amplifying a magnetic field generated from the payment terminal. The processor amplifies a magnetic field generated from the payment terminal, using the attractor; measures an induced voltage, based on the amplified magnetic field; and determines whether the measured induced voltage is greater than the first reference voltage.

In various embodiments of the present disclosure, the processor deactivates the magnetic field detection function for the first loop antenna if the mobile electronic device is close to the payment terminal.

In various embodiments of the present disclosure, the processor provides a notification via a user interface if the mobile electronic device is not close to the payment terminal.

In various embodiments of the present disclosure, the processor determines whether the induced voltage is greater than a second reference voltage which is greater than the first reference voltage; and generates a magnetic field signal containing the card information, using the first loop antenna, if the induced voltage is greater than the first reference voltage but less than the second reference voltage.

In various embodiments of the present disclosure, the processor generates a magnetic field signal containing the card information, using the second loop antenna, if the induced voltage is greater than the second reference voltage.

In various embodiments of the present disclosure, the processor stops generating a magnetic field signal containing the card information, if the mobile electronic device that has been located close to the payment terminal is apart from the payment terminal.

In various embodiments of the present disclosure, the first loop antenna has a resistance and an inductance less than those of the second loop antenna.

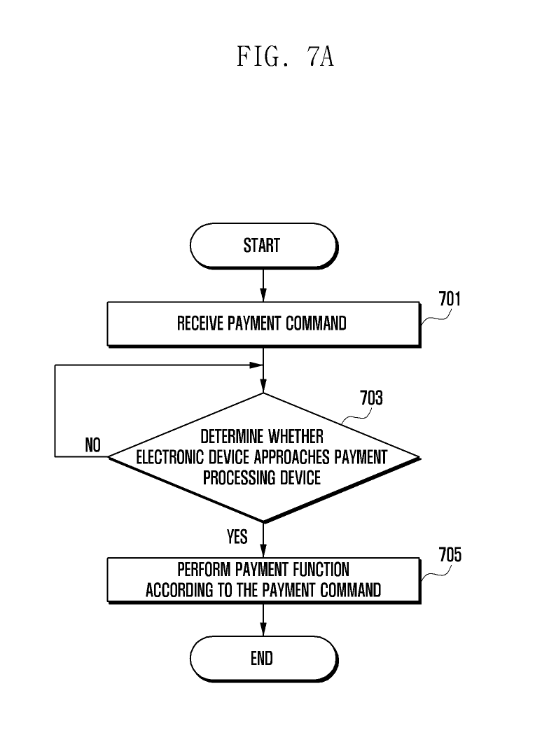

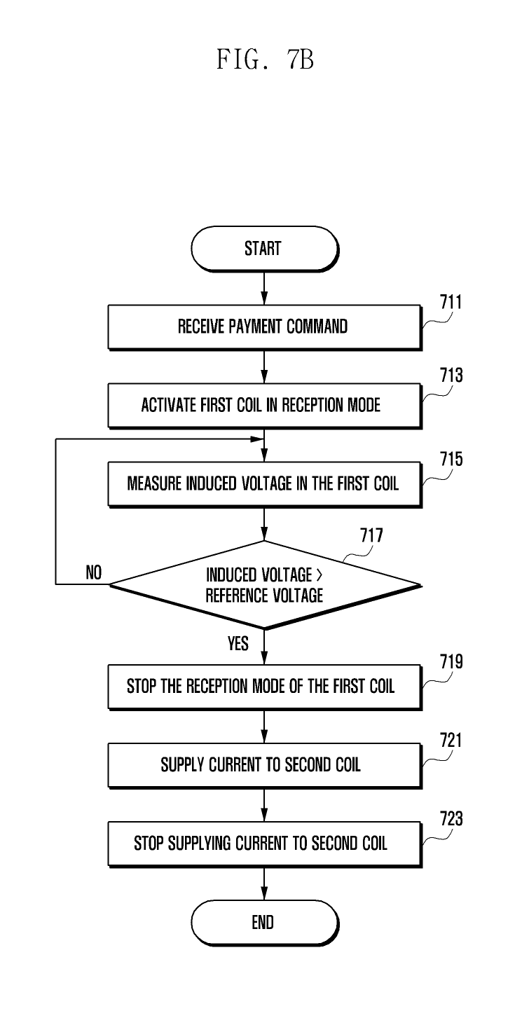

FIGS. 7A and 7B are flowcharts of a method of determining whether an electronic device approaches a payment processing device and generating a magnetic field corresponding to a payment function if the electronic device approaches a payment processing device, according to an embodiment of the present disclosure.

Referring to FIG. 7A, the processor 610 of the electronic device 600 is capable of receiving a payment command in step 701. For example, the processor 610 executes an application (e.g., an application program) to perform a payment. The processor 610 completes user authentication to perform a payment function. The reception of a payment command as in step 701 refers to a state where the user authentication corresponding to a payment function is completed. The payment command may contain a command corresponding to an MST payment mode.

The processor 610 is capable of determining whether the electronic device 600 approaches a payment processing device (e.g., a POS terminal, a payment terminal, etc.) in step 703. The payment processing device is used in the sense of various types of terminals capable of receiving magnetic field signals and performing a payment. The payment processing device includes a magnetic header for reading a magnetic card. The magnetic header operates in an idle mode to read a magnetic card. The magnetic header may be a giant magnetoresistive (GMR) sensor. The payment processing device in an idle mode may generate a weak magnetic field by its magnetism component or noise. The processor 610 is capable of amplifying the weak magnetic field, via the attractor 605. The processor 610 of the electronic device 600 is capable of detecting a magnetic field generated from a payment processing device and measuring induced electromotive force corresponding to the detected magnetic field. The processor 610 is capable of determining whether the electronic device 600 approaches a payment processing device based on the measured induced electromotive force.

The processor 610 is capable of determining whether the electronic device 600 approaches a payment processing device, using a built-in coil antenna (e.g., voltage detecting coil 601, NFC coil 602) in step 703.

If the processor 610 ascertains that the electronic device 600 approaches a payment processing device in step 703, the electronic device 600 is capable of performing a payment function according to the payment command in step 705. The processor 610 is capable of allowing current to flow into one of a number of coils used for performing a payment function installed to the electronic device 600. That is, the processor 610 is capable of applying current, containing card information to perform a payment function, to a coil in step 705. For example, the processor 610 is capable of measuring a distance between the electronic device 600 and a payment processing device; determining whether the electronic device 600 approaches the payment processing device, based on the distance; and transferring a control command to the data creating unit 613. The data creating unit 613 is capable of receiving data containing card information from the card information management unit 630; converting the data into a pulse signal to a logical low/high form; and transferring the converted signal to a coil, e.g., a second coil (e.g., the MST coil 603), via the driver 615. If current flows in the coil, the coil creates a magnetic field signal. That is, the processor 610 is capable of performing a payment function via the magnetic field signal. The processor 610 considers a time that the electronic device 600 approached the payment processing device to be a start timing of a payment function, and generates a magnetic field signal to perform a payment function. The processor 610 is capable of creating a magnetic field signal a preset number of times for a preset period of time.

If the processor 610 ascertains that the electronic device 600 has not approached a payment processing device within a period of time in step 703, the electronic device 600 may end the payment function. The processor 610 may set a length of time to determine whether the electronic device 600 approaches a payment processing device. In this case, if the processor 610 has not recognized that the electronic device 600 approaches a payment processing device within the set period of time in step 703, the electronic device 600 may end the payment function. Alternatively, if the processor 610 receives the payment cancel command, the processor 610 may end the payment function.

Referring to FIG. 7B, the processor 610 is capable of determining whether the electronic device 600 approaches a payment processing device using a first coil (e.g., the voltage detecting coil 601 shown in FIG. 6A or the NFC coil 602 shown in FIG. 6B and described above); and performing a payment function using a second coil (e.g., the MST coil 603 shown in FIG. 6B and described above) if the electronic device 600 has approached a payment processing device.

The processor 610 is capable of receiving a payment command in step 711. Since step 711 shown in FIG. 7B is identical to step 701 shown in FIG. 7A, its detailed description is omitted here.

The processor 610 is capable of activating a reception mode (e.g., a voltage detection function) of the first coil 602 adjacent to the second coil 603 in step 713. The activation of a reception mode may be a process of detecting a magnetic field, generated from an external device (e.g., a payment processing device), and blocking the power supply 650 or switching the power supply 650 from a current state to a pull-down state in order to measure an induced electromotive force generated by the first coil 602, based on the detected magnetic field.

If the reception mode of the first coil 602 is activated in step 713, the processor 610 is capable of measuring the magnitude of a voltage (e.g., the induced voltage) corresponding to the induced electromotive force that the first coil 602 generated in step 715). If the electronic device 600 has approached a payment processing device, the processor 610 is capable of amplifying a magnetic field generated from a payment processing device via the attractor 605 of the electronic device 600. In this case, the magnitude of the induced voltage of the first coil 602 is increased. The measured induced voltage may vary according to the type of payment processing device. The measured induced voltage may also vary according to the distance between the electronic device 600 and the payment processing device. For example, the smaller the distance between the electronic device 600 and the payment processing device, the greater the measured induced voltage.

The processor 610 is capable of comparing the induced voltage of the second coil 603 with a reference voltage stored in the memory in step 717. If the processor 610 ascertains that the induced voltage is greater than a reference voltage in step 717, the processor 610 may end (e.g., deactivate) the reception mode of the first coil 602 in step 719. If the induced voltage is greater than a reference voltage, it indicates that the electronic device 600 is close to a payment processing device so that a payment function may be performed. The processor 610 ends the reception mode of the first coil 602 in step 719, and then supplies current to the second coil 603 in step 721. Step 721 shown in FIG. 7B is identical to step 705 shown in FIG. 7A and described above. The processor 610 is capable of receiving data containing card information from the card information management unit 630 via the data creating unit 613; converting the data into a pulse signal; and transferring the converted signal to the second coil 603 via the driver 615 in step 721. If current flows in the second coil 603, the second coil 603 is capable of generating a magnetic field signal to perform a payment function. That is, the processor 610 is capable of performing a payment function via a magnetic field signal. The processor 610 considers a time that the electronic device 600 has approached a payment processing device to be a start time of a payment function, and generates a magnetic field signal to perform a payment function. The processor 610 stops supplying current to the second coil 603 in step 723. For example, the processor 610 is capable of generating a magnetic field signal a preset number of times for a preset period of time and then stopping the generation of a magnetic field signal if the set period of time has elapsed.

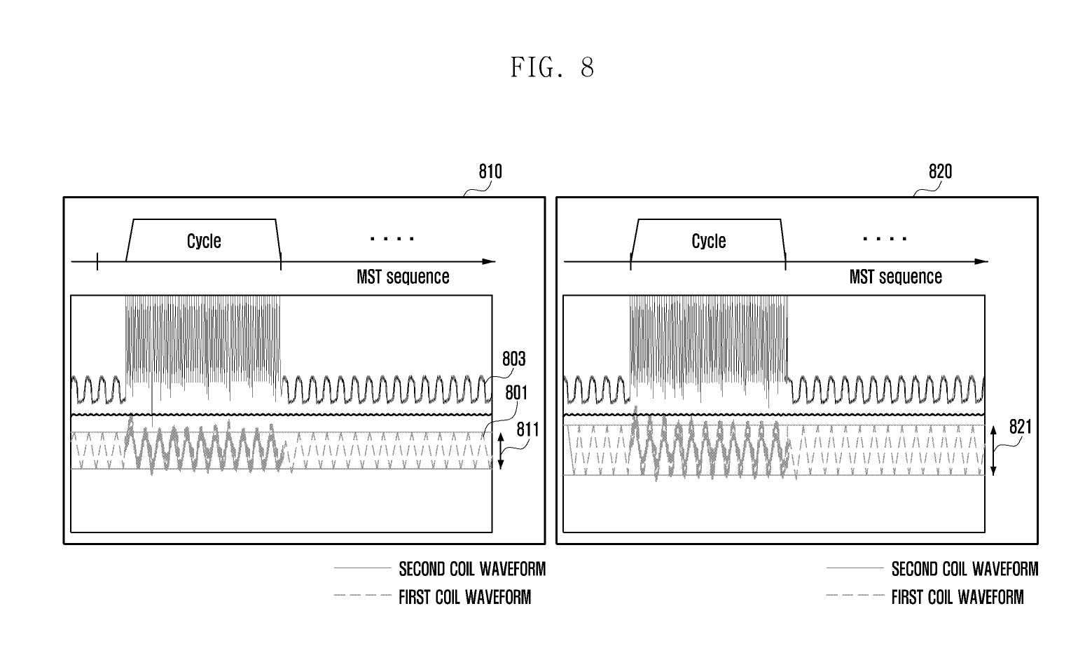

FIG. 8 illustrates diagrams of a result of determining whether an electronic device approaches a payment processing device according to an embodiment of the present disclosure.

Referring to FIG. 8, a voltage waveform 810 is a case if an electronic device 600 is not close to a payment processing device, and a voltage waveform 820 is a case if an electronic device 600 is close to a payment processing device. FIG. 8 also shows a first coil waveform 801 of a voltage in the first coil and a second coil waveform 803 of a voltage in the second coil. The first coil waveform 801 shows a measured voltage which varies according to a condition as to whether the electronic device 600 is close to a payment processing device. The measured magnitude 821 of voltage of the first coil 602 if the electronic device 600 is close to a payment processing device is greater than the measured magnitude 811 of voltage of the first coil 602 if the electronic device 600 is not close to a payment processing device. That is, the electronic device 600 measures a magnitude of a voltage of the first coil 602, and determines whether the electronic device 600 is close to a payment processing device, based on the measured voltage magnitude. The second coil waveform 803 shows the variation of voltage when an MST sequence creates cycles. That is, when a cycle of MST sequence is created, the electronic device 600 flows current into the second coil 603, thereby generating a magnetic field signal.

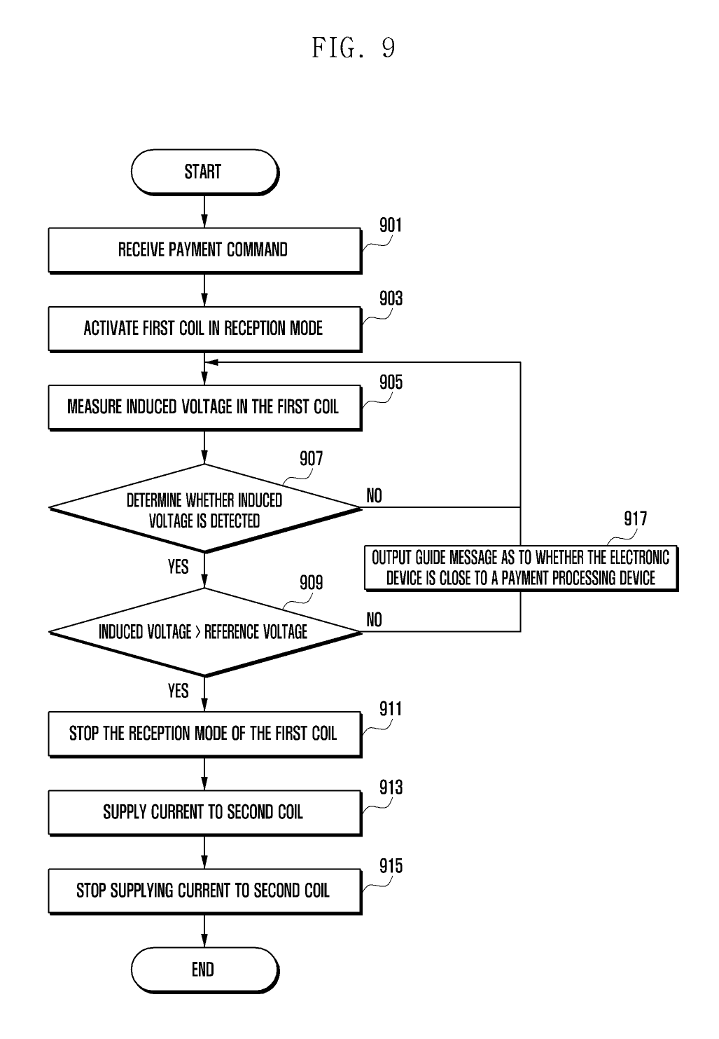

FIG. 9 is a flowchart of a method of determining whether an electronic device approaches a payment processing device via a first coil, and providing a distance between the electronic device and the payment processing device according to an embodiment of the present disclosure.

Referring to FIG. 9, the processor 610 is capable of measuring an induced voltage for a first coil 602 via a first coil (e.g., the first coil 602 shown in FIG. 6B and described above); and determining whether an electronic device approaches a payment processing device, based on the measured induced voltage. If the electronic device 600 is close to a payment processing device, the processor 610 is capable of performing a payment function via the second coil (e.g., the second coil 603 shown in FIG. 6B and described above).

FIG. 9 is a flowchart that describes an embodiment of the present disclosure that is similar to the embodiment shown in FIG. 7B and described above. Since steps 901 to 905 are identical to steps 711 to 715 shown in FIG. 7B and described above, a detailed description of steps 901 to 905 is omitted here.

The processor 610 is capable of detecting induced voltage in the first coil 602 in step 907. If the processor 610 has not detected an induced voltage in the first coil 602 in step 907, the method returns to step 905 to measure an induced voltage, if any, in the first coil 602.

If the processor 610 detects an induced voltage in the first coil 602 in step 907, the processor 610 is capable of determining whether the induced voltage is greater than a reference voltage in step 909. The reference voltage may be a preset value and may be used to determine whether the electronic device 600 is close to a payment processing device so that a payment function may be performed. That is, if the induced voltage is greater than a reference voltage, it indicates that the electronic device 600 is close to a payment processing device so that a payment function may be performed.

If the induced voltage is greater than a reference voltage in step 909, the processor 610 is capable of ending (e.g., deactivating) the reception mode of the second coil 603 in step 911. Since steps 909 to 913 are identical to steps 717 to 723 shown in FIG. 7B and described above, a detailed description of steps 909 to 913 is omitted here.

If the induced voltage is less than or equal to a reference voltage in step 909, the processor 610 is capable of informing a user of a guide message as to whether the electronic device 600 must be closer to a payment processing device in step 917. The measured induced voltage in the first coil 602 may vary depending on the distance between the electronic device 600 and the payment processing device. For example, the smaller the distance between the electronic device 600 and the payment processing device, the greater the measured induced voltage in the first coil 602. That is, the processor 610 is capable of determining whether the electronic device 600 is close to a payment processing device, based on the measured induced voltage in the first coil 602, and providing the user with the determined result, via a display, by a notification. If the induced voltage in the first coil 602 is less than or equal to a reference voltage, the electronic device 600 is capable of informing the user of a guide message so that the user may adjust the location between the electronic device and a payment processing device via user interface (UI)/user experience (UX).

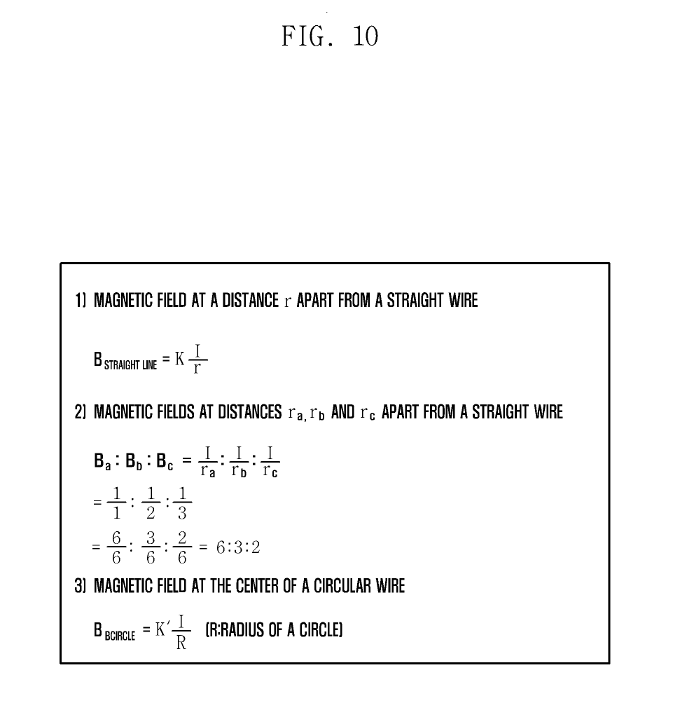

FIG. 10 is a diagram of equations for measuring a distance between an electronic device and a payment processing device according to an embodiment of the present disclosure.

Referring to FIG. 10, B_{straight line} denotes a magnetic field at a distance r apart from a straight wire; rₐ, r_{b}, and r_{c} denote distances from a straight wire to points a, b, and c; Bₐ, B_{b}, and B_{c} denote magnetic fields; and B_{circle} denotes a magnetic field at the center of a circular wire.

The magnitude of a magnetic field is inversely proportional to the distance between the electronic device 600 and a payment processing device. The greater the distance between the electronic device 600 and a payment processing device, the less the magnitude of a magnetic field. The electronic device 600 is capable of measuring an induced voltage in the first coil 602, and detecting the distance between the electronic device 600 and a payment processing device based on the measured induced voltage.

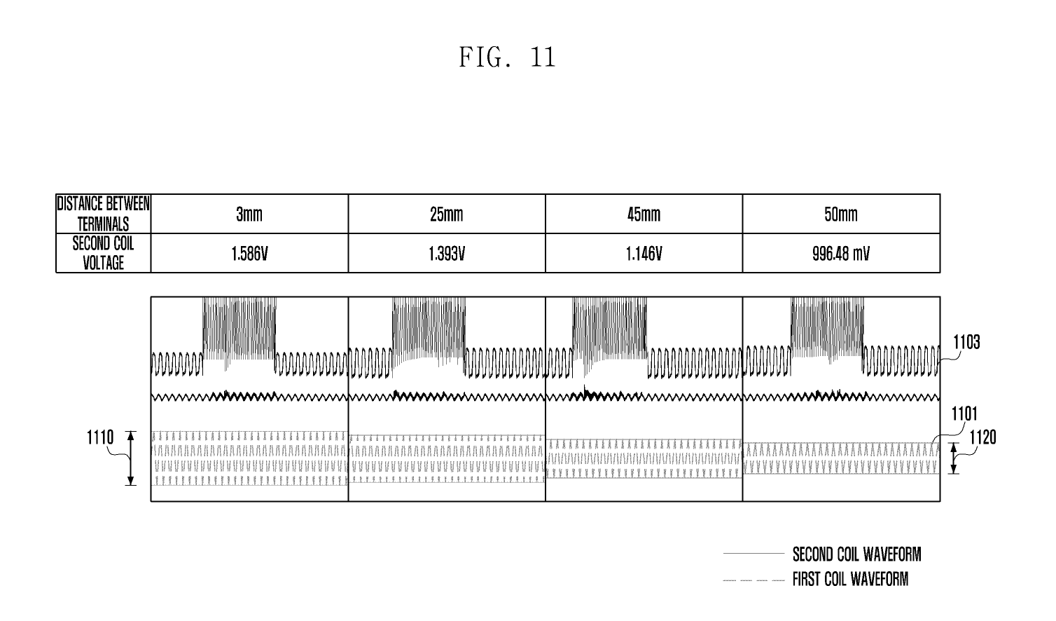

FIG. 11 illustrates a diagram and a table of induced voltages measured according to distances between an electronic device and a payment processing device according to an embodiment of the present disclosure.

Referring to FIG. 11, the measured induced voltage in the second coil 603 of the electronic device 600 is inversely proportional to the distance between the electronic device 600 and a payment processing device. FIG. 11 also shows a first coil waveform 1101 of a voltage in the first coil 601 and a second coil waveform 1103 of a voltage in the second coil 603. A payment function corresponding to the first coil 601 may be performed using the first coil 601. Therefore, the first coil waveform 1101 may be constant regardless of the distance between the electronic device 600 and a payment processing device. A measurement of an induced voltage in the second coil 603 may vary according to the distance between the electronic device 600 and a payment processing device. For example, if the distance between the electronic device 600 and a payment processing device is 3 mm, the induced voltage 1110 in the second coil 603 may be 1.586 V. If the distance between the electronic device 600 and a payment processing device is 50 mm, the induced voltage 1120 in the second coil 603 may be 996.48 mV. That is, the greater the distance between the electronic device 600 and the payment processing device, the lesser the magnitude of the induced voltage in the second coil 603. The electronic device 600 is capable of detecting a distance between the electronic device 600 and a payment processing device based on the induced voltage in the second coil 603; providing a user with the detected distance, and informing the user of a guide message if the electronic device 600 must be moved closer to the payment processing device.

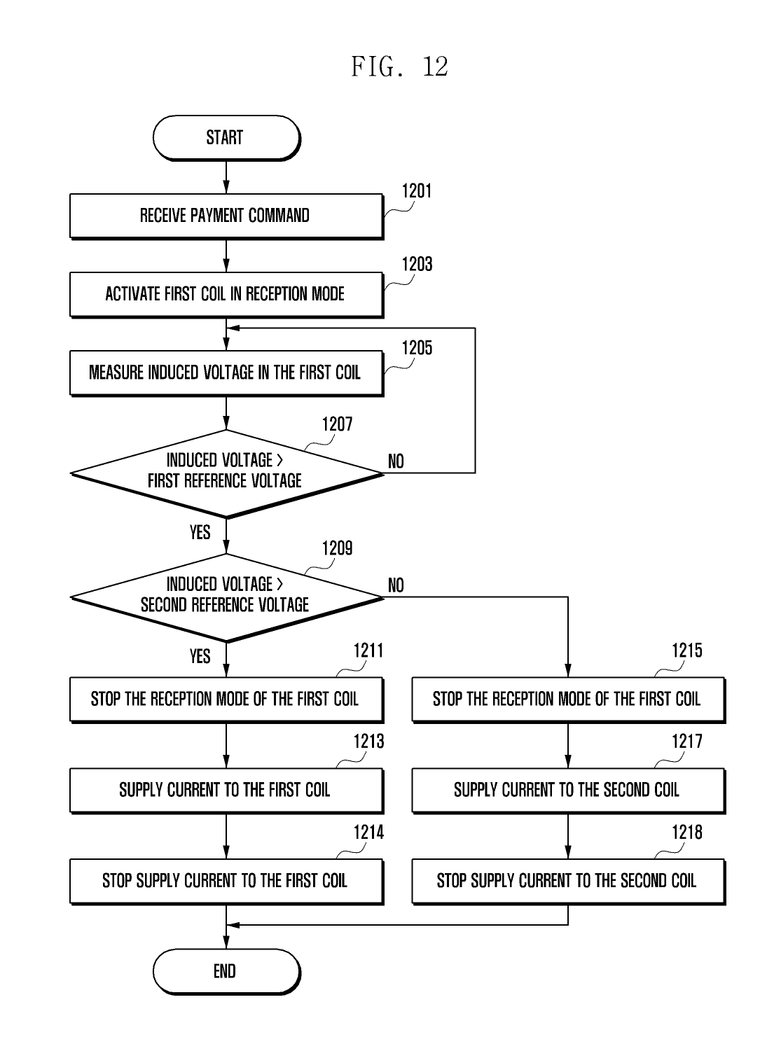

FIG. 12 is a flowchart of a method of supporting a number of payment modes using a number of coils, according to an embodiment of the present disclosure.

Referring to FIG. 12, the processor 610 is capable of measuring an induced voltage in the first coil 602 via a first coil (e.g., the first coil 602 shown in FIG. 6B and described above); and checking payment modes which can be processed by a payment processing device, based on the measured induced voltage. The processor 610 is capable of supplying current to a coil (e.g., a first coil, a second coil) corresponding to the checked payment mode, and performing a payment function in a payment mode with the coil through which current flows. The payment processing device is capable of supporting a number of payment modes and performing a payment function in one of the payment modes.

FIG. 12 is a flowchart of an embodiment of the present disclosure which is similar to the embodiment shown in FIG. 7B and described above. Since steps 1201 to 1205 are identical to steps 711 to 715 shown in FIG. 7B described above, a detailed description of steps 1201 to 1205 is omitted here. In FIG. 12, the received payment command may be a payment command which does not set a certain payment mode.

The processor 610 is capable of determining whether the induced voltage in the first coil 602 is greater than a first reference voltage in step 1207. If the processor 610 ascertains that the induced voltage in the first coil 602 is greater than the first reference voltage in step 1207, the processor 610 is capable of determining whether the induced voltage is greater than a second reference voltage in step 1209. The first reference voltage may be preset, and used to determine a voltage corresponding to one of a number of payment modes. Like the first reference voltage, the second reference voltage may be preset to determine a voltage corresponding to one of a number of payment modes. The first reference voltage may be a reference voltage value corresponding to a magnetic field created based on a magnet of a payment processing device. The second reference voltage may be a reference voltage value corresponding to a magnetic field created from a payment processing device. That is, the second reference voltage may be greater than the first reference voltage. The payment processing device is capable of processing at least one of a number of payment modes. The intensity of the magnetic field created by the payment processing device may vary depending on the payment mode.

If the induced voltage is greater than a second reference voltage in step 1209, the processor 610 is capable of ending (e.g., deactivating) the reception mode of the first coil 602 in step 1211. The processor 610 determines that a payment mode which can be processed by the payment processing device is a payment mode corresponding to the first coil 602, based on the measured induced voltage. The processor 610 supplies current to the first coil 602 in step 1213, thereby creating a magnetic field signal of a payment mode corresponding to the first coil 602. The processor 610 stops supplying current to the first coil 602 in step 1214, and thus ends the creation of the magnetic field signal. The electronic device 600 is capable of checking a payment mode of a payment processing device, based on the induced voltage in the first coil 602, and performing a payment function using a coil corresponding to the payment mode.

In addition, if the induced voltage is less than or equal to a second reference voltage in step 1209, the processor 610 is capable of ending (e.g., deactivating) the reception mode of the first coil 602 in step 1215. The processor 610 determines that a payment mode which can be processed by the payment processing device is a payment mode corresponding to the second coil 603, based on the induced voltage being less than the second reference voltage. The processor 610 supplies current to the second coil 603 in step 1217, thereby creating a magnetic field signal of the payment mode corresponding to the second coil 603. The processor 610 stops supplying current to the second coil 603 in step 1218, and thus ends the generation of the magnetic field signal. The electronic device 600 is capable of checking a payment mode of a payment processing device, using a second coil 603, and performing a payment function corresponding to one of a number of payment modes, using the second coil 603.

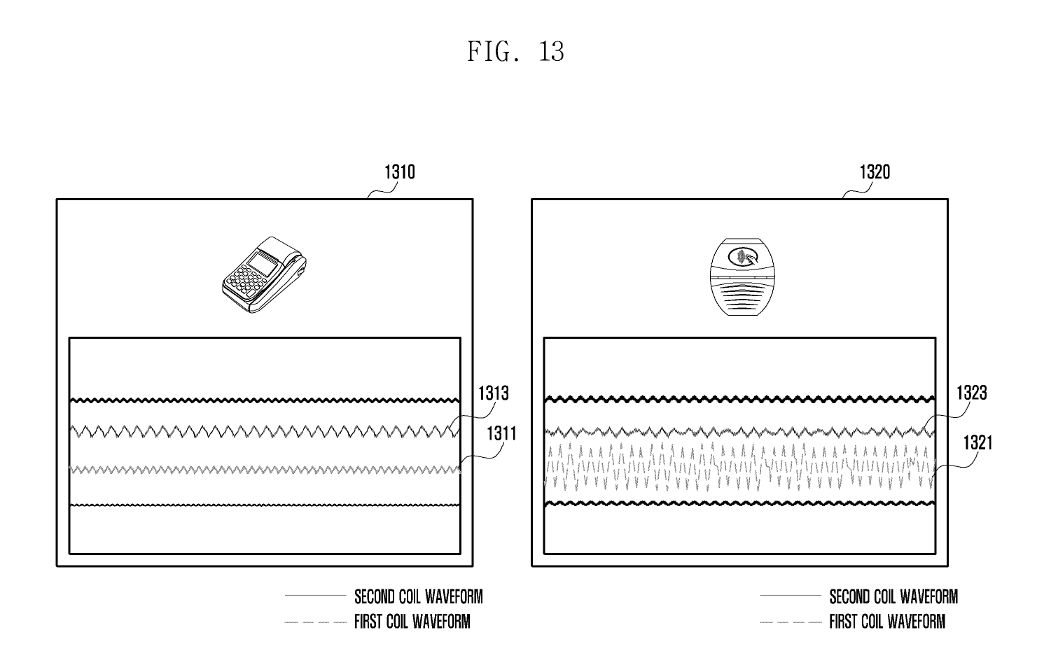

FIG. 13 illustrates waveform diagrams of induced voltages which are measured according to payment modes, according to an embodiment of the present disclosure.

Referring to FIG. 13, magnetic field signals generated by a payment processing device differ from each other according to the payment modes which it can process. More specifically, FIG. 13 illustrates a magnetic field signal 1310 for a first payment processing device (e.g., an MST payment processing device) supporting a payment mode corresponding to a second coil 603 and a magnetic field signal 1320 for a second payment processing device (e.g., an NFC payment processing device) supporting a payment mode corresponding to a second coil 602. The first coil waveform 1321 of the magnetic field signal 1320 for the second payment processing device is greater than the first coil waveform 1311 of the magnetic field signal 1310 for the first payment processing device. That is, the processor 610 is capable of detecting a type of payment processing device (e.g., a type of payment mode which can be processed by a payment processing device) based on the measured magnetic field signal, using the first coil 602. The electronic device 600 is capable of determining a payment mode of a payment processing device using the first coil 602 and performing a payment function using the first coil 602 or second coil 603 corresponding to the determined payment mode.

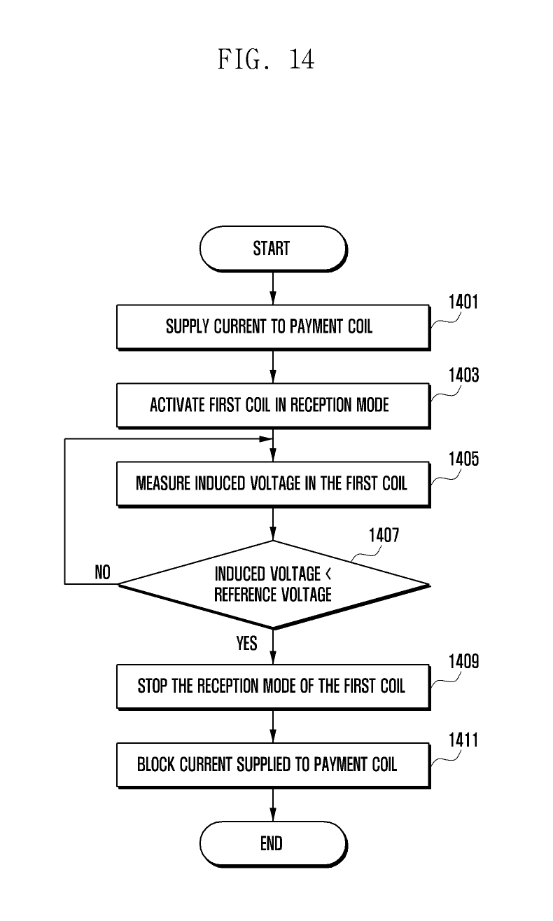

FIG. 14 is a flowchart of a method of determining whether a payment processing device and an electronic device are separated by a preset distance, using a first coil, and stopping the generation of a magnetic field from a second coil, according to an embodiment of the present disclosure.

Referring to FIG. 14, the processor 610 supplies current to a payment coil (e.g., the second coil 603) in step 1401. For example, step 1401 may be identical to step 721 shown in FIG. 76 and described above. Alternatively, the processor 610 performs a payment function in a payment mode corresponding to a payment coil in step 1401.

The processor 610 is capable of activating a first coil 602 in a reception mode in step 1403. The first coil 602 in a reception mode may be a activated by blocking a power supply 650 to measure an induced voltage generated in the first coil 602 through a magnetic field signal generated by an external system or switching the power supply 650 from a current state to a pull-down state. The processor 610 supplies current to a payment coil (e.g., the second coil 603), and activates the first coil 602 in a reception mode in step 1403.

The processor 610 is capable of measuring an induced voltage (e.g., an induced electromotive force) generated in the first coil 602 through a magnetic field signal generated by an external system (e.g., a payment processing device) in step 1405.

The processor 610 is capable of comparing an induced voltage of the first coil 602 with a reference voltage stored in memory in step 1407. If the processor 610 ascertains that the induced voltage of the first coil 602 is less than a reference voltage in step 1407, the processor 610 is capable of ending (e.g., deactivating) the reception mode of the first coil 602 in step 1409. If the induced voltage is less than a reference voltage, it indicates that the electronic device 600 is farther away from a payment processing device than a preset distance. The preset distance is a range of distances within which a payment processing device can receive and process a magnetic field signal corresponding to a payment signal from the electronic device 600. If the processor 610 ascertains that the electronic device 600 is away from a payment processing device by a distance greater than or equal to the preset distance in step 1409, the processor 610 is capable of deactivating the reception mode of the first coil 602 (e.g., ending the reception mode of the first coil 602).

The processor 610 is capable of blocking current supplied to the payment coil (e.g., the second coil 603) in step 1411, thereby stopping the payment function and thus reducing power consumption.

In various embodiments of the present disclosure, the electronic device 600 is capable of determining whether the electronic device 600 is close to a payment processing device; and performing, if the electronic device 600 is close to the payment processing device, a payment function from a time when the electronic device 600 is close to the payment processing device. Alternatively, the electronic device 600 is capable of determining whether it is not close to a payment processing device; and stopping (e.g., blocking), if the electronic device is not close to the payment processing device, the payment function from a time when the electronic device 610 is not close to the payment processing device. The electronic device 600 is capable of minimizing the generation of a magnetic field required to perform a payment function and the power consumption while performing the payment function.

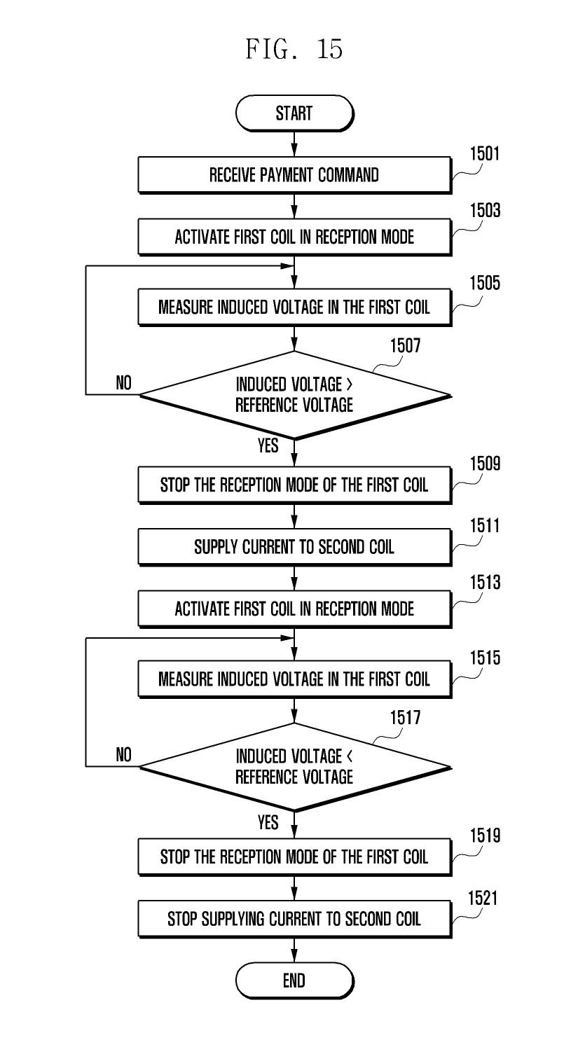

FIG. 15 is a flowchart of a method of determining whether an electronic device is close to a payment processing device; performing a payment function based on the determination; determining whether an electronic device is away from a payment processing device; and stopping a payment function based on the determination, according to an embodiment of the present disclosure.

FIG. 15 is a flowchart that describes an embodiment of the present disclosure which is similar to the embodiment shown in FIG. 7B and described above. Since steps 1501 to 1511 are identical to steps 711 to 721 shown in FIG. 7B and described above, a detailed description of steps 1501 to 1511 is omitted here.

Referring to FIG. 15, the processor 610 supplies current to a second coil 603 in step 1511. The processor 610 performs a payment function in response to a payment command in step 1511.

Since steps 1513 to 1519 are identical to steps 1403 to 1409 shown in FIG. 14 and described above, a detailed description of steps 1403 to 1409 is omitted here.

The processor 610 stops supplying current to the second coil 603 in step 1521.

In various embodiments of the present disclosure, the electronic device 600 is capable of determining whether it is close to a payment processing device; and performing, if it is close to the payment processing device, a payment function from a time when the electronic device 600 is close to the payment processing device. Alternatively, the electronic device 600 is capable of determining whether the electronic device is away from a payment processing device and stopping (e.g., blocking), if the electronic device 600 is away from the payment processing device, the payment function from a time when the electronic device 600 is away from the payment processing device. The electronic device is capable of minimizing the time required for performing a payment function and, thus, power consumption according to the payment function.

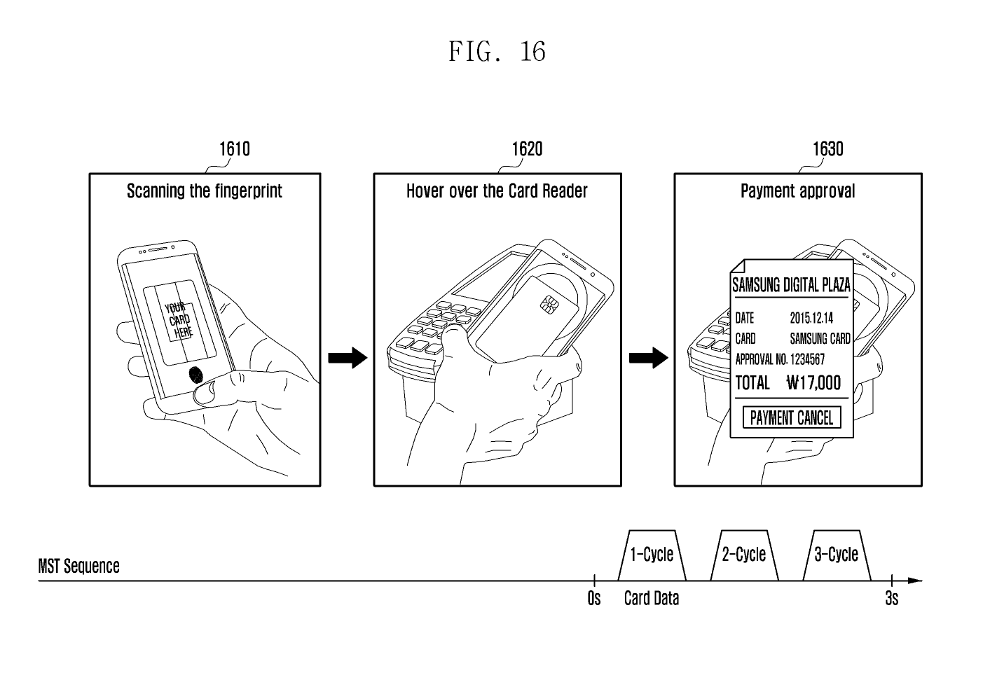

FIG. 16 illustrates diagrams of a method of determining whether an electronic device is close to a payment processing device; performing a payment function, based on the determination; determining whether an electronic device is away from a payment processing device; and stopping a payment function based on the determination, according to an embodiment of the present disclosure.

Referring to FIG. 16, the payment process (e.g., a payment sequence) is divided into three processes. For example, the payment method includes a process of authenticating a user to perform a payment function (e.g., fingerprint authentication, password authentication, iris authentication, etc.) as shown in diagram 1610 (e.g., process 1); a process of hovering an electronic device over a payment processing deice (e.g., a POS terminal) as shown in diagram 1620 (e.g., process 2); and a process of completing a payment via the payment processing device as shown in diagram 1630 (e.g., process 3).

In various embodiments of the present disclosure, the electronic device is capable of considering a time 1620 when it is close to a payment processing device to be a start time of a payment function (e.g., the generation time of a magnetic field signal); and generating a magnetic field signal corresponding to a payment function. The electronic device is capable of considering a time 1630 of a payment completion (e.g., a time when the electronic device starts to move away from a payment processing device) to be an ending time of a payment function (e.g., a time when the magnetic field signal is blocked); and stopping the generation of a magnetic field signal corresponding to the payment function.

In various embodiments of the present disclosure, the electronic device considers a time when the electronic device is close to a payment processing device to be a generation time of a magnetic field signal corresponding to a payment function, thereby providing users with a convenient payment experience.

In various embodiments of the present disclosure, the electronic device is capable of determining a start time and an ending time of a payment function according to ambient conditions. Therefore, the electronic device is capable of minimizing the generation of a magnetic field signal corresponding to a payment function, thereby reducing the power consumption concerning the generation of magnetic field signal.

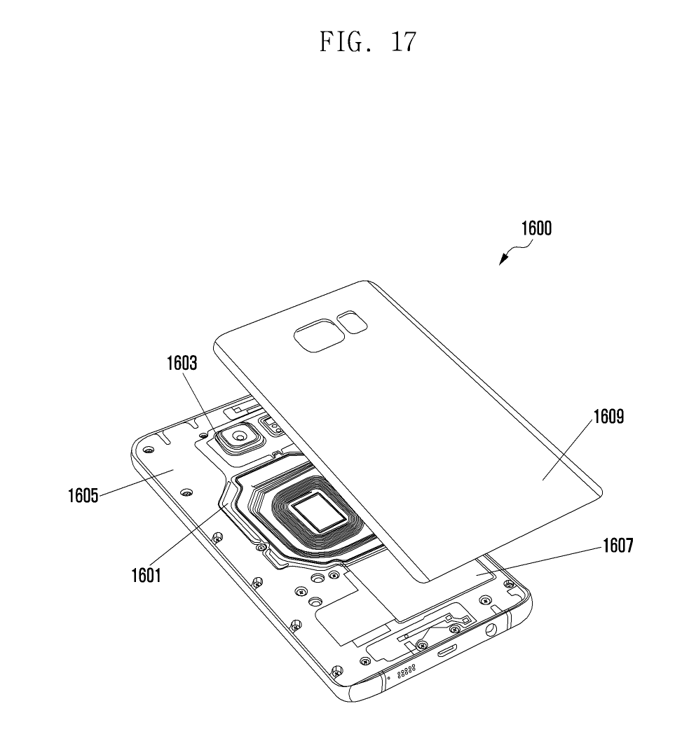

FIG. 17 is a diagram illustrating a location and a shape of an FPCB installed in an electronic device according to an embodiment of the present disclosure.

Referring to FIG. 17, an exploded rear-side perspective view of an electronic device 1600 when a cover 1609 is removed is shown. The electronic device 1600 is configured to include an FPCB 1601 in which one or more coils are arranged, a camera 1603, a battery 1607, and a housing 1605 for fixing the components in place. Although the electronic device 1600 is shown with the cover 1609 separated from the body of the electronic device 1600, it should be understood that the present disclosure is not limited to a condition where the cover 1609 is separated from the electronic device 1600. It should be understood that the FPCB 1601 may be arranged in the middle of the electronic device 1600.

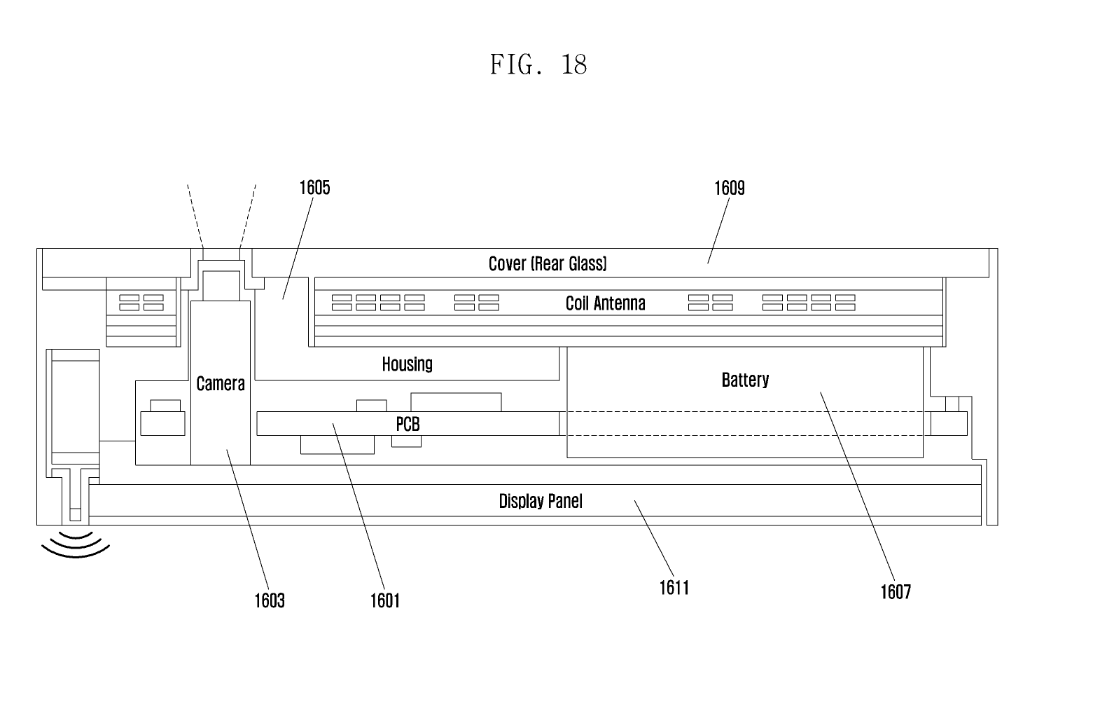

FIG. 18 is a cross-sectional side view of an electronic device including an FPCB, according to an embodiment of the present disclosure.

Referring to FIG. 18, a cross-sectional side view of an electronic device 1600 is illustrated, showing internal structure. A display panel 1611 of the electronic device 1600 is located at the bottom of FIG. 18 and the cover 1609 for the rear side of the electronic device 1600 is located at the top of FIG. 18. An FPCB 1601 of the electronic device 1600 is located between a camera 1603 and a battery 1607. Alternatively, the FPCB 1601 may be located between the display panel 1611 and a housing 1605.

In various embodiments of the present disclosure, a payment method using loop antennas in a mobile electronic device is configured in such a way as to include determining whether the mobile electronic device is close to an external payment terminal, using a first loop antenna of a PCB which is built in a central area of the mobile electronic device; and generating, if the mobile electronic device is close to an external payment terminal, a magnetic field signal including card information to make a payment, via the first loop antenna and/or a second loop antenna of the PCB, in response to a payment command.

In various embodiments of the present disclosure, determining whether the mobile electronic device is close to an external payment terminal includes activating a magnetic field detection function for the first loop antenna in order to detect an ambient magnetic field; detecting a magnetic field generated from the payment terminal, using the first loop antenna; determining whether an induced voltage corresponding to the detected magnetic field is greater than a first reference voltage; and ascertaining that the mobile electronic device is close to the payment terminal if an induced voltage is greater than a first reference voltage.

In various embodiments of the present disclosure, determining whether an induced voltage is greater than a first reference voltage includes amplifying the detected magnetic field, using an attractor which is built in the electronic device and located close to the first loop antenna; measuring an induced voltage, based on the amplified magnetic field; and determining whether the measured induced voltage is greater than the first reference voltage.

In various embodiments of the present disclosure, the method further includes deactivating the magnetic field detection function for the first loop antenna if the mobile electronic device is close to the payment terminal.

In various embodiments of the present disclosure, the method further includes providing a notification via a user interface if the mobile electronic device is not close to the payment terminal.

In various embodiments of the present disclosure, the method further includes determining whether the induced voltage is greater than a second reference voltage which is greater than the first reference voltage; and generating a magnetic field signal containing the card information, using the first loop antenna, if the induced voltage is greater than the first reference voltage but less than the second reference voltage.

In various embodiments of the present disclosure, the method further includes generating a magnetic field signal containing the card information, using the second loop antenna, if the induced voltage is greater than the second reference voltage.

In various embodiments of the present disclosure, the method further includes stopping the generation of a magnetic field signal containing the card information, if the mobile electronic device that has been located near the payment terminal is away from the payment terminal. In various embodiments of the present disclosure, the card information contains data corresponding to tracks 1, 2 and 3 of a magnetic card.

In various embodiments of the present disclosure, a payment method using loop antennas in a mobile electronic device is configured in such a way as to include generating a magnetic field signal including card information to make a payment via a second loop antenna of a PCB built in the central area of the mobile electronic device; determining whether the mobile electronic device is away from a payment terminal, using a first loop antenna of the PCB; and stopping the generation of the magnetic field signal via the second loop antenna if the mobile electronic device is away from the payment terminal.

In various embodiments of the present disclosure, determining whether the mobile electronic device is away from a payment terminal includes activating a magnetic field detection function for the first loop antenna in order to detect an ambient magnetic field; detecting a magnetic field generated from the payment terminal, using the first loop antenna; determining whether an induced voltage corresponding to the detected magnetic field is less than a first reference voltage; and ascertaining that the mobile electronic device is away from the payment terminal if an induced voltage is less than a first reference voltage.

In various embodiments of the present disclosure, a payment method using loop antennas in a mobile electronic device is configured in such a way as to include determining whether the mobile electronic device is close to an external payment terminal, using a first loop antenna of a PCB which is built in a central area of the mobile electronic device; and generating, if the mobile electronic device is close to an external payment terminal, a magnetic field signal including card information to make a payment, via a second loop antenna of the PCB, in response to a payment command.

Various embodiments of the present disclosure are capable of receiving a payment command; determining whether an electronic device is close to a payment processing device via a coil of the electronic device in response to the received payment command; and executing a payment function corresponding to the payment command from the time when a determination is made as to whether an electronic device is close to a payment processing device. In addition, various embodiments of the present disclosure are capable of detecting a time when an electronic device starts to move away from a payment processing device, via a coil (e.g., loop antenna) of the electronic device, in the process of payment function; and stopping the payment function at the detection timing. In addition, various embodiments of the present disclosure are capable of providing a user with a convenient payment experience; and reducing power consumption caused by the execution of a payment function.

The term “module” used in the present disclosure may refer to a certain unit that includes one of hardware, software and firmware or any combination thereof. The term “module” may be interchangeably used with the terms “unit,” “logic,” “logical block,” “component,” and “circuit,” for example. The term “module” may refer to a minimum unit, or part thereof, which performs one or more particular functions. The term “module” may refer to a device that is formed mechanically or electronically. For example, the term “module” may refer to at least one of an application specific integrated circuit (ASIC), a field programmable gate array (FPGA), and a programmable-logic device, which are known or will be developed.

At least part of a device (e.g., modules or functions thereof) or a method (e.g., steps) according to various embodiments of the present disclosure may be implemented as commands stored, e.g., in the form of a program module, in a non-transitory computer-readable recording medium. In the case where commands are executed by at least one processor, the at least one processor may perform a particular function corresponding to the commands. The non-transitory computer-readable recording medium may be, for example, a memory. At least some of the program module may be implemented (e.g., executed) by, for example, the at least one processor. At least some of the program module may include, for example, a module, a program, a routine, a set of instructions, and/or a process for performing one or more functions.

The non-transitory computer-readable recording medium may include magnetic media such as a hard disk, a floppy disk, and a magnetic tape, optical media such as a compact disc read only memory (CD-ROM) and a DVD, magneto-optical media such as a floptical disk, and hardware devices specially configured to store and perform a program instruction. In addition, the program instructions may include high level language code, which can be executed in a computer by using an interpreter, as well as machine code generated by a compiler. The aforementioned hardware device may be configured to operate as one or more software modules in order to perform the operation of various embodiments of the present disclosure, and vice versa.

A module or programming module according to various embodiments of the present disclosure may include or exclude at least one of the above-discussed elements or further include another element. The operations performed by the module, the programming module or any other element according to various embodiments of the present disclosure may be executed sequentially, in parallel, repeatedly, or by a heuristic method. Additionally, some operations may be executed in different orders or omitted, or another operation may be added.

While the present disclosure has been particularly shown and described with reference to an embodiment thereof, it will be understood by those skilled in the art that various changes in form and details may be made therein without departing from the scope of the disclosure as defined by the appended claims and their equivalents.

What is claimed is:

1. A mobile electronic device, comprising:
a printed circuit board (PCB) built into a central area of the mobile electronic device and including at least one of a first loop antenna or a second loop antenna;
a processor electrically connected to the at least one of the first loop antenna or the second loop antenna;
a memory electrically connected to the processor, and configured to store card information related to a payment,
wherein the processor is configured to determine whether the mobile electronic device is close to an external payment terminal, using the first loop antenna; and generate, if the mobile electronic device is close to the external payment terminal, a magnetic field signal including the card information, via the at least one of the first loop antenna or the second loop antenna, in response to a payment command.

2. The electronic device of claim 1, wherein the processor is further configured to:
activate a magnetic field detection function for the first loop antenna in order to detect an ambient magnetic field;
detect a magnetic field generated by the external payment terminal, using the first loop antenna;
determine whether an induced voltage corresponding to the detected magnetic field is greater than a first reference voltage; and
ascertain that the mobile electronic device is close to the payment terminal if the induced voltage is greater than the first reference voltage.

3. The electronic device of claim 2, further comprising:
an attractor built into the electronic device and located close to the first loop antenna, and configured to amplify the magnetic field generated from the external payment terminal,
wherein the processor is further configured to:
amplify the magnetic field generated by the payment terminal, using the attractor;
measure the induced voltage, based on the amplified magnetic field; and
determine whether the measured induced voltage is greater than the first reference voltage.

4. The electronic device of claim 2, wherein the processor is further configured to:
deactivate the magnetic field detection function for the first loop antenna if the mobile electronic device is close to the external payment terminal,
provide a notification via a user interface if the mobile electronic device is not close to the external payment terminal.

5. The electronic device of claim 2, wherein the processor is further configured to:
determine whether the induced voltage is greater than a second reference voltage which is greater than the first reference voltage; and
generate a first magnetic field signal containing the card information, using the first loop antenna, if the induced voltage is greater than the first reference voltage but less than the second reference voltage.

6. The electronic device of claim 5, wherein the processor is further configured to:
generate a second magnetic field signal containing the card information, using the second loop antenna, if the induced voltage is greater than the second reference voltage.

7. The electronic device of claim 1, wherein the processor is further configured to stop generating a magnetic field signal containing the card information, if the mobile electronic device which was previously located near the external payment terminal is presently away from the external payment terminal.

8. The electronic device of claim 1, wherein the first loop antenna has a resistance and an inductance less than those of the second loop antenna.

9. A payment method using loop antennas in a mobile electronic device, comprising:
determining whether the mobile electronic device is close to an external payment terminal, using a first loop antenna of a printed circuit board (PCB) which is built into a central area of the mobile electronic device; and
generating, if the mobile electronic device is close to the external payment terminal, a magnetic field signal including card information to make a payment, via at least one of the first loop antenna or a second loop antenna of the PCB, in response to a payment command.

10. The method of claim 9, wherein determining whether the mobile electronic device is close to the external payment terminal comprises:
activating a magnetic field detection function for the first loop antenna in order to detect an ambient magnetic field;
detecting a magnetic field generated by the external payment terminal, using the first loop antenna;
determining whether an induced voltage corresponding to the detected magnetic field is greater than a first reference voltage; and
ascertaining that the mobile electronic device is close to the external payment terminal if the induced voltage is greater than the first reference voltage.

11. The method of claim 10, wherein determining whether the induced voltage is greater than the first reference voltage comprises:
amplifying the detected magnetic field, using an attractor which is built into the mobile electronic device and located close to the first loop antenna;
measuring the induced voltage, based on the amplified magnetic field; and
determining whether the measured induced voltage is greater than the first reference voltage.

12. The method of claim 10, further comprising:
deactivating the magnetic field detection function for the first loop antenna if the mobile electronic device is close to the external payment terminal.

13. The method of claim 9, further comprising:
providing a notification via a user interface if the mobile electronic device is not close to the external payment terminal.

14. The method of claim 10, further comprising:
determining whether the induced voltage is greater than a second reference voltage which is greater than the first reference voltage; and
generating a first magnetic field signal containing the card information, using the first loop antenna, if the induced voltage is greater than the first reference voltage but less than the second reference voltage.

15. The method of claim 14, further comprising:
generating a second magnetic field signal containing the card information, using the second loop antenna, if the induced voltage is greater than the second reference voltage.

16. The method of claim 9, further comprising:
stopping the generation of the magnetic field signal containing the card information, if the mobile electronic device that was previously located near the external payment terminal is currently away from the payment terminal.

17. The method of claim 9, wherein the card information contains:
data corresponding to tracks 1, 2 and 3 of a magnetic card.

18. The method of claim 9, further comprising:
generating a magnetic field signal including card information to make a payment, via a second loop antenna of a printed circuit board (PCB) built into a central area of the mobile electronic device;
determining whether the mobile electronic device is away from a payment terminal, using a first loop antenna of the PCB; and
stopping the generation of the magnetic field signal via the second loop antenna if the mobile electronic device is away from the payment terminal.

19. The method of claim 18, wherein determining whether the mobile electronic device is away from the payment terminal comprises:
activating a magnetic field detection function for the first loop antenna in order to detect an ambient magnetic field;
detecting the magnetic field generated by the payment terminal, using the first loop antenna;
determining whether an induced voltage corresponding to the detected magnetic field is less than a first reference voltage; and
ascertaining that the mobile electronic device is away from the payment terminal if the induced voltage is less than a first reference voltage.

20. The method of claim 9, further comprising:
generating, if the mobile electronic device is close to the external payment terminal, a magnetic field signal including card information to make a payment, via a second loop antenna of the PCB, in response to a payment command.
